(19) United States
(12) Patent Application Publication
(10) Pub. No.: US 2005/0285998 A1
(43) Pub. Date: Dec. 29, 2005

(54) Optical compensation film, ellipsoidal polarizing plate, and liquid crystal display

(75) Inventors: Hirofumi Saita, Minami-ashigara-shi (JP); Minoru Wada, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/058,314

(22) Filed: Feb. 16, 2005

(30) Foreign Application Priority Data
Feb. 16, 2004 (JP) 2004-038108
Mar. 22, 2004 (JP) 2004-083037
Mar. 26, 2004 (JP) 2004-090979
Sep. 27, 2004 (JP) 2004-279866

(51) Int. Cl. G02F 1/1335

(52) U.S. Cl. 349/117

(57) ABSTRACT

Novel optical compensation films are disclosed. One embodiment of the films is an optical compensation film wherein d satisfies the equation of d=−0.0115×Rth+3.0 d (μm) or is within the range of ±10% thereof, in which d (μm) is a thickness of the optically anisotropic layer and Rth (nm) is the retardation of only the transparent support in the thickness direction. Another embodiment of the films is an optical compensation film wherein a (deg.) and b (deg.) are within the ranges of 20≦a≦80 and 20≦b≦80, and satisfy the relation of − 5/9×a+45≦b≦− 5/9×a+110, in which a (deg.) is an average of tilt angles of the major axes (the discotic planes) of the discotic compound molecules at an interface between the optically anisotropic layer and the transparent support, and b (deg.) is an average of tilt angles of the major axes (the discotic planes) of the discotic compound molecules at an air interface on the side of a liquid crystal cell.

### CROSS-REFERENCE TO RELATED APPLICATIONS

This application claims benefit of priority under 35 USC 119 to Japanese Patent Application No. 2004-038108 filed Feb. 16, 2004; Japanese Patent Application No. 2004-083037 filed Mar. 22, 2004; Japanese Patent Application No. 2004-090979 filed Mar. 26, 2004; and Japanese Patent Application No. 2004-279866 filed Sep. 27, 2004.

### TECHNICAL FIELD

The present invention relates to an optical compensation film having an optically anisotropic layer comprising a liquid crystal molecule, and an ellipsoidal polarizing plate and a liquid crystal display using the same.

### BACKGROUND ART

Liquid crystal displays comprise a liquid crystal cell, a polarizer, and an optical compensation film (a retardation film). In transmission type liquid crystal displays, two polarizers are disposed on the both sides of the liquid crystal cell, and one or two optical compensation films are disposed between the cell and the polarizers. In reflection type liquid crystal displays, a reflecting plate, the liquid crystal cell, the optical compensation film, and the polarizer are disposed in this order. The liquid crystal cell comprises rod-like liquid crystal molecules, two substrates for enclosing the molecules, and an electrode layer for applying voltage to the molecules. Various display modes of the liquid crystal cell have been proposed. Depending on the alignment state of the rod-like liquid crystal molecules, a transmission type liquid crystal cell can employ a mode of TN (Twisted Nematic), IPS (In-Plane Switching), FLC (Ferroelectric Liquid Crystal), OCB (Optically Compensatory Bend), STN (Supper Twisted Nematic), VA (Vertically Aligned), or ECB (Electrically Controlled Birefringence), and a reflection type liquid crystal cell can use a mode of TN, HAN (Hybrid Aligned Nematic), or GH (Guest-Host).

The optical compensation film is used in various liquid crystal displays to prevent undesired coloration and to enlarge viewing angle. Commonly used are optical compensation films formed of stretched birefringent polymer films or comprising a transparent support and an optically anisotropic layer of liquid crystal molecules formed thereon. The optical properties of the optical compensation film are selected depending on the optical properties of the liquid crystal cell, specifically on the display mode. Optical compensation films with various optical properties suitable for the display mode of the liquid crystal cell can be produced by using the liquid crystal molecules therein. Various optical compensation films, which employ the liquid crystal molecules to correspond to various display modes, have been proposed.

An alignment state of rod-like liquid crystal molecules under voltage in a TN mode liquid crystal cell is shown in FIGS. 9 and 10. FIG. 9 shows the relation between inclination of the rod-like molecules in the polar angle direction and position of the rod-like molecules in the liquid crystal layer thickness direction, and FIG. 10 shows the relation between inclination of the rod-like molecules in the azimuth angle direction and position of the rod-like molecules in the liquid crystal layer thickness direction. Curves in FIGS. 9 and 10 correspond to several tens voltages applied to the liquid crystal layer. In FIG. 9, the θ polar angle represents inclination of the rod-like molecule with regard to the z-axis direction in the case of using the liquid crystal layer plane as xy-plane. The term “the polar angle is 0°” means that the rod-like molecule is parallel to the liquid crystal layer plane, and the term “the polar angle is 90°” means that the rod-like molecule is parallel to the normal line of the liquid crystal layer. Further, in FIG. 10, the φ azimuth angle is inclination of the rod-like molecule with regard to one of orthogonal axes in the layer plane. For example, in a case where the right of the liquid crystal cell in the horizontal direction is the plus side of the x-axis, the φ azimuth angle means the angle of the rod-like molecule to the x-axis in the counterclockwise direction. FIGS. 9 and 10 show an example of common alignment state of the TN liquid crystal display mode obtained by design simulation software for liquid crystal displays.

As the optical compensation film for enlarging the viewing angle of the TN mode liquid crystal display cell, films containing a discotic liquid crystal compound fixed in the hybrid alignment state have been put into practical use (Japanese Patent No. 2,587,398, etc.) The discotic compound in the film compensates the nematic liquid crystal cell containing the rod-like liquid crystal, and thus the film can compensate also an obliquely incident light to extremely enlarge the display viewing angle. In this case, as shown in FIG. 11, compensation films 54a, 54b comprising a discotic compound 53 are disposed respectively on the display surface and the back surface of a TN liquid crystal cell 51 containing rod-like liquid crystal molecules 52 in the twisted nematic alignment state, and a backlight 55 is placed in the side of the back surface. In common normally white mode TN liquid crystal displays, the azimuth angle direction of the discotic compound is designed such that the black display is effectively compensated under an applied voltage to reduce black transmittance in the directions of up, down, left, and right, thereby enlarging the viewing angle.

Though using discotic liquid crystal can enlarge the viewing angle, it cannot prevent the grayscale inversion on the underside of the display. The twisted alignment of the nematic liquid crystal 52 in a cross section of a liquid crystal layer of the driven TN mode liquid crystal cell 51 is schematically shown in FIG. 12 to explain this phenomenon. The left of the drawing is the underside of the display, and the right is the upside. Arrows A, B, and C represent observing directions. Retardation is reduced as the observing direction is moved from the arrow B in the direction of an arrow 2, and then the retardation is increased as the observing direction is moved in the direction of an arrow 1. The retardation is minimum in the case of observing the liquid crystal layer in the direction of C, and the retardation observed in the direction of A is equal to the retardation observed in the direction of B. Thus, the transmittance is constant in the two directions of A and B, and is the smallest in the direction of C. A polar angle, at which the transmittance is minimum, depends on tone levels, thereby resulting in crossing of the tone levels (the grayscale inversion of the transmittance). The grayscale inversion on the underside of the display in this case is shown in FIG. 13. In FIG. 13, the above-described optical compensation film using the discotic liquid crystal for enlarging the viewing angle is used in a commercially available TN liquid crystal TV. It is understandable that, when front luminance is classified into 7 levels and the variation thereof in the vertical direction is plotted, the curves of L1 and L2 intersect and cause the grayscale inversion at about 35° on the underside. The TN mode liquid crystal displays are generally designed such that the grayscale inversion occurs on the underside, on which the grayscale inversion is less conspicuous.

In view of improving the display properties of the TN mode liquid crystal displays, a liquid crystalline, optical compensation film having a twisted structure has been proposed (Japanese Patent No. 3,445,689). In this film, angles of directors of the discotic liquid crystal molecules to the normal line of a film plane vary in the film thickness direction, and the molecules are fixed in a twisted hybrid alignment state. As described in Japanese Patent No. 3,445,689, a normally white TN liquid crystal display using the compensation film has polar angles of 32° on the upside, 41° on the underside, 38° on the left side, and 38° on the right side at the contrast 30.

### DISCLOSURE OF THE INVENTION

By the method described in the above patent publication, in a TN liquid crystal display, a range of the viewing angle (the contrast viewing angle), in which a high contrast can be achieved, was enlarged. However, the problem of the grayscale inversion on the underside was not solved. As the TN mode liquid crystal displays are more widely used in notebook computers, monitors, TVs, etc. recently, there is an increasing demand for solving the problem of the grayscale inversion on the underside. Under such circumstances, an object of the present invention is to industrially improve the grayscale inversion on the underside and the contrast viewing angles in the vertical and horizontal directions, thereby further widening the application of the TN mode liquid crystal displays. The angle, at which the curves L1 and L2 in FIG. 13 intersect with each other, was defined as grayscale inversion angle, and liquid crystal displays were evaluated in terms of the grayscale inversion angle. As a result, it was found that the desirable grayscale inversion angle of the liquid crystal display is 37° or more. In view of producing an optical compensation film having an optically anisotropic layer of a discotic compound industrially, it is important that the above properties, specifically the grayscale inversion and the contrast viewing angle, be both improved, the optical compensation film be produced with high productivity by uniformly applying the discotic compound rapidly and by hardening and drying the discotic compound, and unevenness due to the optical compensation film be prevented from occurring on the display surface.

An object of the invention is to provide an optical compensation film, which can be thinned with the adaptation to production, and can improve both of the grayscale inversion on the underside and the contrast viewing angle of a TN mode liquid crystal display.

The inventors have noticed that, in an optical compensation film comprising an optically anisotropic layer of a discotic compound and a transparent support thereof, the birefringence of a liquid crystal layer can be compensated by the two layer of the transparent support and the optically anisotropic layer. And they conducted various studies in view of providing an optically anisotropic layer with the most effective compensatory properties, and, as a result, the inventors have found that optical compensation ability of the optical compensation film is drastically improved in a case where the optical properties such as Rth of the transparent support and the thickness, the tilt angle, or the twist angle of the optically anisotropic layer satisfy a particular condition. The present invention has been accomplished based on the finding. Various optical compensation films excellent in the above properties and optical compensation of a liquid crystal cell were produced and disposed between the liquid crystal cell of a liquid crystal display and each of upper and lower polarizers, so that the display properties of the liquid crystal display were evaluated to study the performances of the optical compensation films.

Further, the inventors have found that the grayscale inversion can be improved and the viewing angle can be enlarged also by selecting the tilt angle of a discotic compound, which can actively compensate liquid crystal molecules inducing the grayscale inversion without reducing voltage applied to the liquid crystal layer. The invention has been accomplished based also on the finding.

The first embodiment of the present invention provides an optical compensation film comprising a transparent support and an optically anisotropic layer formed of a composition comprising a discotic compound, wherein angles of the discotic planes of the discotic compound molecules against the film plane varies in the film thickness direction, and when a (deg.) is an average of angles between the film plane and the major axes (the discotic planes) of the discotic compound molecules, b (deg.) is an average of angles between the major axes (the discotic planes) of the discotic compound molecules and air interface at the air interface, β is a mean value of a (deg.) and b (deg.), and Rth (nm) is retardation of only the transparent support in the thickness direction, the tilt angle of the discotic compound is controlled such that β satisfies the following equation or is within the range of ±7% thereof:
β=−0.0006×Rth²+0.1125×Rth+35.

It is preferred that, when d (μm) is the thickness of the optically anisotropic layer and Rth (nm) is the retardation of only the transparent support in the thickness direction, the thickness of the optically anisotropic layer is preferably determined such that d satisfies the following equation or is within the range of ±10% thereof;
d=−0.0115×Rth+3.0.

It is preferred that, when d (μm) is the thickness of the optically anisotropic layer and φ (deg.) is a twist angle of the discotic compound from the transparent support interface to the air interface, the twist structure of the layer is preferably such that φ satisfies the following equation or is within the range of φ(d)±15% thereof:
φ(d)=21.3×d−39.8.

When a liquid crystal display using the optical compensation film is driven, the effective driving voltage is preferably 5 to 60% smaller than V1, which is an effective driving voltage for achieving a desired black transmittance without the optical compensation film.

The second embodiment of the present invention provides an optical compensation film comprising a transparent support and an optically anisotropic layer formed of a composition comprising a discotic compound, wherein when a (deg.) is an average of the tilt angles of the major axes (the discotic planes) of the discotic compound molecules at the interface between the optically anisotropic layer and the transparent support, and b (deg.) is an average of the tilt angles of the major axes (the discotic planes) of the discotic compound molecules at the air interface on the side of a liquid crystal cell, the tilt structure formed of the discotic compound molecules is such that a (deg.) and b (deg.) are within the ranges of 20≦a≦80 and 20≦b≦80, and satisfy the relation of − 5/9×a+45≦b≦− 5/9×a+110.

It is preferred that the optical compensation film, when Rth (nm) is the retardation of only the transparent support in the thickness direction and d (μm) is the thickness of only the optically anisotropic layer, has Rth (nm) and d (μm) satisfy the relation of 255×Exp(−0.66×d)<Rth<330×Exp(−0.46×d).

In view of preventing generation of phase difference due to heat distortion, etc., the optical compensation films described above preferably has a photoelastic coefficient of 16×10⁻¹² (1/Pa) or less.

The optical compensation film may be used in combination with a polarizer, whereby it is practically efficient and advantageous that the optical compensation film is laminated with a transparent protective film and a polarizing film preliminarily to obtain an ellipsoidal polarizing plate. Thus, the invention relates also to an ellipsoidal polarizing plate having a transparent protective film, a polarizing film, and the optical compensation film described above.

The invention further relates to a liquid crystal display comprising the optical compensation film, and to a liquid crystal display comprising a pair of polarizers and a liquid crystal cell disposed between the polarizers, at least one of the polarizers being the ellipsoidal polarizing plate of the invention. It is preferred that the liquid crystal display of the invention has a total viewing angle of 240° or more at a contrast of 10 or more in the directions of up, down, left, and right, and have a grayscale inversion angle of 37° or more on the underside.

In this invention, Re(λ) and Rth(λ) represent an in-plane retardation and a retardation in a thickness direction at a wavelength λ respectively, unless otherwise noted. Re(λ) is measured by means of KOBRA 21ADH (manufactured by Oji Scientific Instruments) by irradiating a light with a wavelength of λ nm in the normal line direction of the film. Rth(λ) is calculated by KOBRA 21ADH based on 3 retardation values measured in terms of 3 directions, which are Re(λ), a retardation value obtained by irradiating a light with a wavelength of λ nm from a direction tilted at +40° to the film normal line using an in-plane retardation axis (detected by KOBRA 21ADH) as a tilt axis (rotation axis), and a retardation value obtained by irradiating the light from a direction tilted at −40° to the film normal line using the in-plane retardation axis as a tilt axis (rotation axis). As assumed values of average refractive indexes, values described in Polymer Handbook (JOHN WILEY & SONS, INC.) and catalogs of various optical films can be used in the invention. Unknown average refractive indexes can be measured by Abbe refractometer. The average refractive indexes of major optical films are as follows: cellulose acylate (1.48), cycloolefin polymer (1.52), polycarbonate (1.59), polymethyl methacrylate (1.49), polystyrene (1.59). By inputting the assumed values of the average refractive indexes and thickness, nx, ny, and nz are calculated by KOBRA 21ADH.

By disposing the optical compensation films of the present invention between the liquid crystal cell and the upper and lower polarizing films, both of a wide contrast viewing angle and improvement of grayscale inversion on the underside can be achieved. Rth of the transparent support and the optical anisotropy of the discotic compound are utilized for compensation, and the transparent support can cancel the retardation in the liquid crystal layer thickness direction, whereby the thickness of the discotic compound layer can be reduced. By using the thin discotic compound layer, alignment defect can be improved and uniformity can be increased. Further, a drying step and a hardening step in production of the optically anisotropic layer of the discotic compound can be completed in a short period of time, whereby high-speed production can be achieved to increase productivity. Thus, according to the invention, there are provided the optical compensation film and the ellipsoidal polarizing plate excellent in industrial productivity, and the liquid crystal display having a display quality higher than those of conventional displays. Further, by reducing the photoelastic coefficient, occurrence of phase difference in the compensation film can be prevented, and light transmittance unevenness can be eliminated, the unevenness being provided in the case of keeping the liquid crystal display at a high temperature.

### BRIEF DESCRIPTION OF THE DRAWINGS

FIG. 1 is a graph showing a relation between the retardation Rth of a transparent support and the thickness d of a discotic compound layer in an optical compensation film according to a first embodiment of the present invention.

FIG. 2 is a graph showing a relation between the retardation Rth of the transparent support and the mean value β of averages a and b, which are average angles of discotic planes against interfaces in the discotic compound layer in the optical compensation film according to the first embodiment of the invention.

FIG. 3 is a graph showing relations between the thickness d, the twist angle φ, and the grayscale inversion angle of the discotic liquid crystal layer in the optical compensation film according to the first embodiment of the invention.

FIG. 4 is a graph showing a relation between the average a of angles of discotic planes of the discotic compound molecules against a transparent support and the average b of angles of discotic planes against substrate interface of a liquid crystal cell for drive display in various optical compensation films according to a second embodiment of the invention.

FIG. 5 is a graph showing relations between the retardation Rth (nm) in the thickness direction of a transparent support and the thickness d of a discotic compound layer in various optical compensation films.

FIG. 6 is a schematic enlarged view showing a twisted hybrid alignment of discotic liquid crystal molecules in the optical compensation film according to the first embodiment of the invention.

FIG. 7 is a schematic view showing an example of basic structure of a transmission type liquid crystal display according to first and second embodiments of the invention.

FIG. 8 is a schematic enlarged view showing a hybrid alignment of discotic liquid crystal molecules in the optical compensation film according to the second embodiment of the invention.

FIG. 9 is a graph showing the relation between the polar tilt angle and the thickness direction of a nematic rod-like liquid crystal in a common TN mode liquid crystal cell.

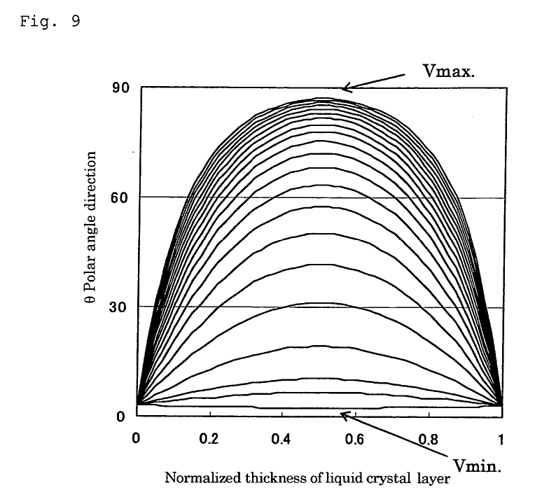

FIG. 10 is a graph showing the relation between the twist angle in the azimuth angle direction and the thickness direction of a nematic rod-like liquid crystal in the common TN mode liquid crystal cell.

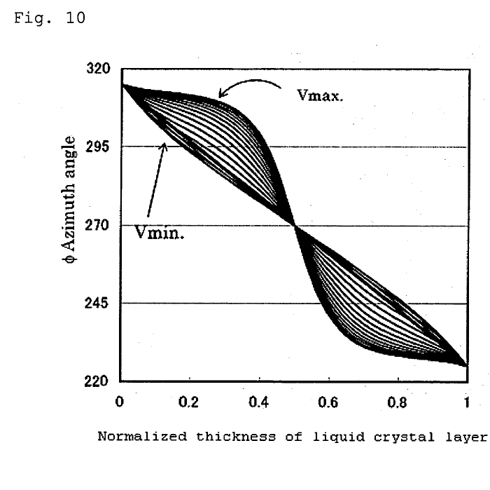

FIG. 11 is a schematic view showing twist of nematic rod-like liquid crystal molecules and orientation of discotic liquid crystal molecules in optical compensation films in a common TN mode liquid crystal cell.

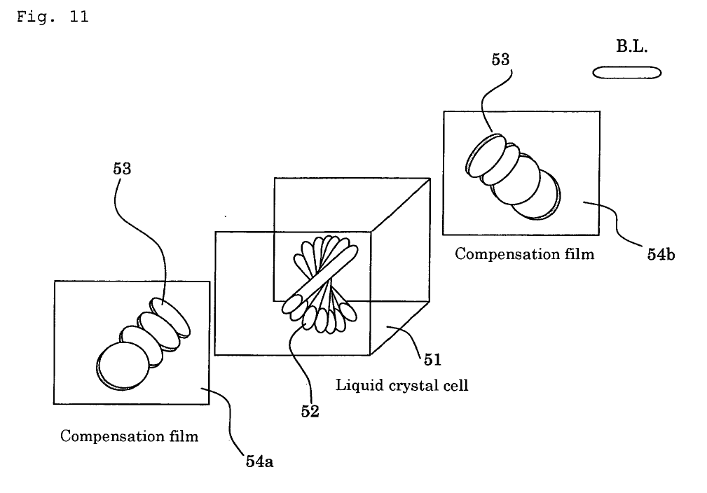

FIG. 12 is a schematic view used for explaining occurrence of grayscale inversion in a TN mode liquid crystal cell.

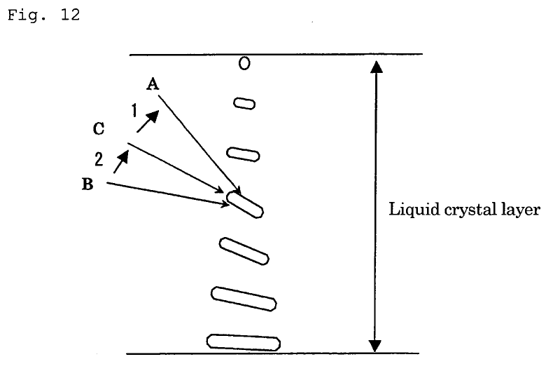

FIG. 13 is a graph showing the relation between the vertical viewing angle and the luminance of a liquid crystal display using a conventional optical compensation film, and the arrow in this graph represents a viewing angle at which grayscale inversion occurs.

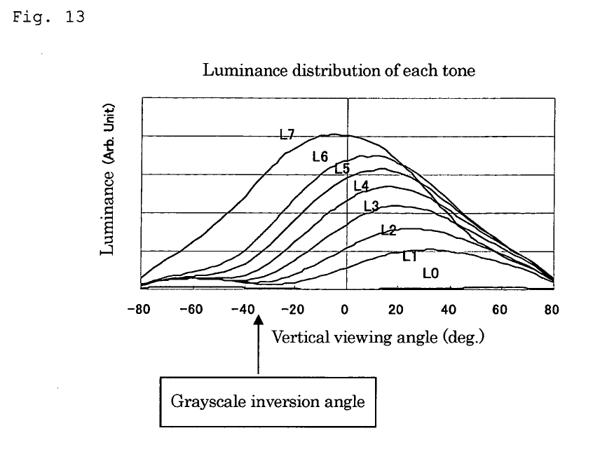

Signs in the drawings have the following meanings.
1a, 1b Transparent protective film
2a, 2b Polarizing film
3, 3a, 3b Transparent support
4, 4a, 4b Optically anisotropic layer
5a, 5b Upper and lower substrates of liquid crystal cell
6 Rod-like liquid crystal layer
BL Backlight
d Discotic compound
de Major axis of discotic compound
51 Liquid crystal cell
52 Rod-like liquid crystal molecule
53 Schematic view of discotic compound
54a, 54b Schematic view of alignment direction of discotic compound to liquid crystal cell

### DETAILED DESCRIPTION OF THE INVENTION

The present invention will be described in detail below.

The optical compensation film according to a first embodiment of the invention comprises a transparent support and an optically anisotropic layer formed of a composition comprising a discotic compound on the support, and satisfies the following condition of (1). The optical compensation film preferably satisfies one of the following conditions of (2) and (3), and more preferably satisfies both of the conditions.

(1) When a (deg.) is an average of angles of the major axes (the discotic planes) of the discotic compound molecules against the film plane in the optically anisotropic layer, b (deg.) is an average of angles of the major axes (the discotic planes) of the discotic compound molecules against air interface at the air interface, β is a mean value of a (deg.) and b (deg.), and Rth (nm) is retardation of only the transparent support in the thickness direction, the relation of β=−0.0006×Rth²+0.1125×Rth+35 is satisfied.

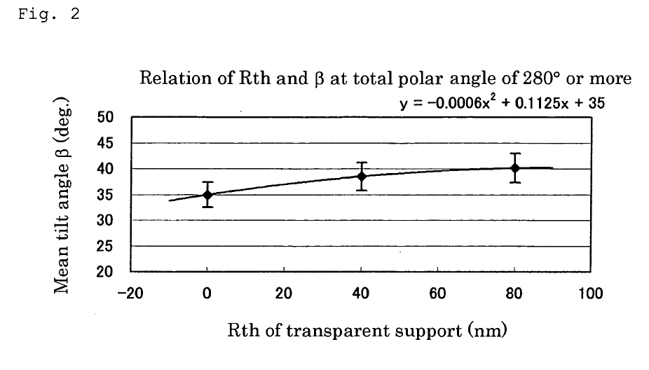

In the case of using the optical compensation film satisfying the condition of (1), a total polar angle at a contrast of 10 in the directions of up, down, left, and right is 280° or more against a normal line of the display. The relation between β and Rth satisfying the condition of (1) is shown in FIG. 2. The embodiments having β, which is not completely coincided with β(Rth) and is within a certain range of error, can give advantageous effects as well as gave by the embodiment having β which is completely coincided with β(Rth). β is preferably within the range of β(Rth)±15%, more preferably within the range of β(Rth)±10%, further preferably within the range of β(Rth)±7%.

(2) When d (μm) is the thickness of the optically anisotropic layer and Rth (nm) is the retardation of only the transparent support in the thickness direction, the relation of d=−0.0115×Rth+3.0 is satisfied.

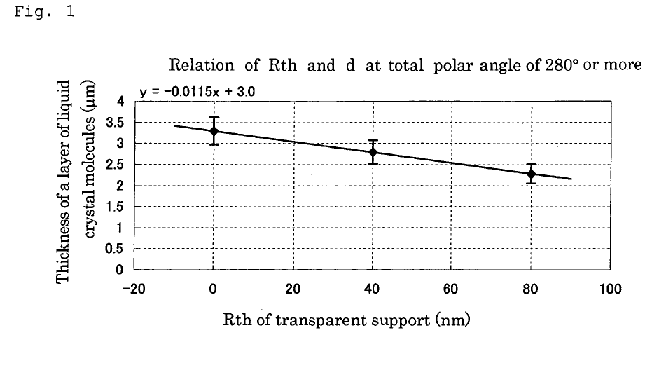

In the case of using the optical compensation film satisfying the condition of (2), the contrast viewing angle is improved as compared with conventional ones, and a total polar angle at a contrast of 10 in the directions of up, down, left, and right is 280° or more against a normal line of the display. The relation between d and Rth satisfying the condition of (2) is shown in FIG. 1. The embodiments having d, which is not completely coincided with d(Rth) and is within a certain range of error, can give advantageous effects as well as gave by the embodiment having d which is completely coincided with d(Rth). The thickness d of the optically anisotropic layer is preferably within the range of d(Rth)±30%, more preferably within the range of d(Rth)±20%, further preferably within the range of d(Rth)±10%.

(3) When d (μm) is the thickness of the optically anisotropic layer and φ (deg.) is a twist angle of the discotic compound from the transparent support interface to the air interface, the relation of φ(d)=21.3×d−39.8 is satisfied.

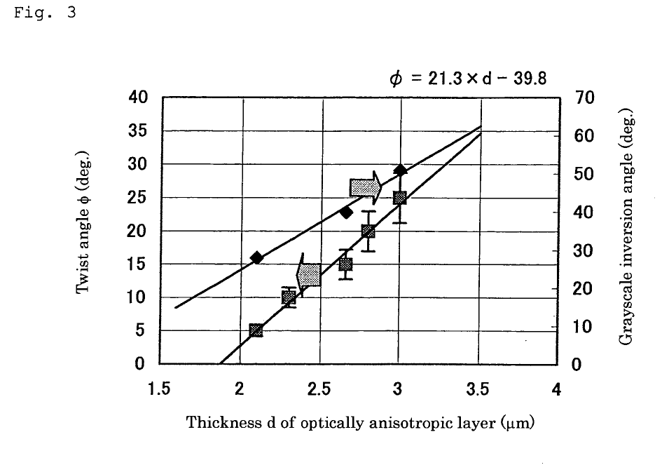

In the case of using the optical compensation film satisfying the condition of (3), the grayscale inversion on the underside of the display is most effectively improved with the thickness of the discotic liquid crystal molecule layer. The relation between φ and d satisfying the condition of (3) is shown by a line on the bottom right in FIG. 3. Further, the relation between the thickness d and the grayscale inversion angle, which is obtained using three optical compensation films having the optically anisotropic layer with different thickness, is shown by a line on the upper left in FIG. 3. The embodiments having the twist angle φ, which is not completely coincided with φ(d) and is within a certain range of error, can give advantageous effects as well as gave by the embodiment having the twist angle φ which is completely coincided with φ(d). φ is preferably within the range of φ(d)±30%, more preferably within the range of φ(d)±20%, further preferably within the range of φ(d)±15%.

The optical compensation film according to a second embodiment of the invention satisfies the above condition of (5).

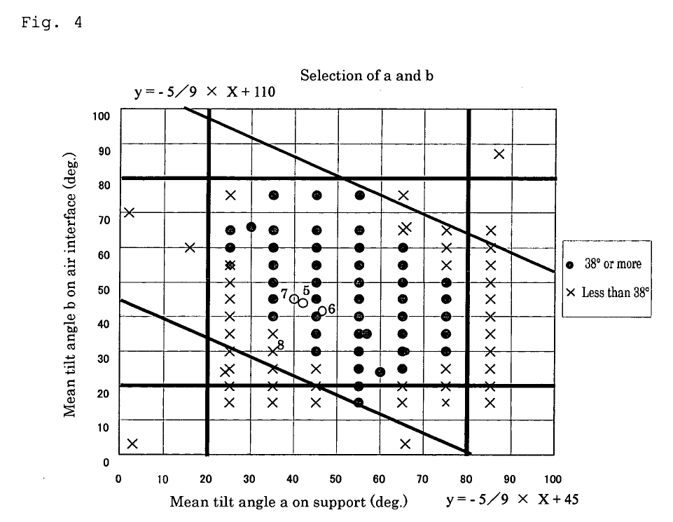

Various optical compensation films comprising a transparent support and a discotic liquid crystal molecule layer were produced, the films being different in the average a (deg.) of the tilt angles of the major axes (the discotic planes) of the discotic compound molecules at the interface of between the optically anisotropic layer and the transparent support, and in the average b (deg.) of the tilt angles of the major axes (the discotic planes) of the discotic compound molecules at the air interface (or at the interface of a liquid crystal cell). The relation of a and b with the grayscale inversion angle of each produced sample is shown in the graph of FIG. 4. As a result of practically using each produced optical compensation film for optical compensation of a liquid crystal display, the optical compensation films having the mean tilt angles a and b satisfying the condition of (4) had the grayscale inversion angles of 38° or more on the underside from the normal line of the display. Under this condition, the occurrence of the grayscale inversion can be particularly prevented, and the contrast viewing angle of the liquid crystal display can be widened. The mean tilt angles a and b were obtained such that the optically anisotropic layer was obliquely cut and the mean tilt angle of the molecules were measured in each part by polarization raman spectroscopy.

Further, the inventor has found that the optical compensation film of the second embodiment is particularly excellent in the compensation function in a case where the optical compensation film satisfies the condition of (6). Thus, the enlarged grayscale inversion angle and the wide contrast viewing angle are both achieved under the condition of angles a and b, when Rth (nm) is the retardation of only the transparent support in the thickness direction, d (μm) is the thickness of only the optically anisotropic layer, Rth and d satisfy the relation of (6) of 255×Exp(−0.66×d)<Rth<330×Exp(−0.46×d), and the optical compensation film is inserted between the liquid crystal cell and the upper and lower polarizers. This has been understandable from the results of noticing the relation between the thickness d of the optically anisotropic layer and Rth of the transparent support, producing various optical compensation films using various optically anisotropic layers with different thicknesses d and various transparent supports with different Rth's, using each film for optical compensation of a TN mode liquid crystal cell, and measuring the display contrast.

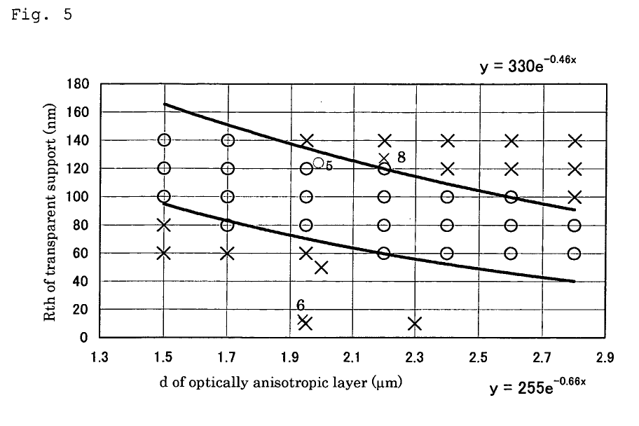

The examined relations between the thickness d of the optically anisotropic layer and Rth of the transparent support are shown in FIG. 5. Polar angles against the normal line of the display surface at contrast of 10 or more were measured from the directions of up, down, left, and right, and the total thereof was obtained. In this graph, the circles O means that the total of the polar angles in the directions of up, down, left, and right was 240° or more.

As is understandable from the graph of FIG. 5, the optical compensation films satisfying the relation, which are on the upside of the curve of y=255×e^{-0.66x} and on the underside of the curve of y=330×e^{-0.46x}, have the total polar angles of 240° or more in the directions of up, down, left, and right at the contrast ratio of 10 or more, to be excellent in the viewing angle properties. Further, it is also understandable that the optical compensation films not satisfying the relation show narrow contrast viewing angles.

The photoelastic coefficient of the optical compensation film of the first or second embodiment is preferably 16×10⁻¹² (1/Pa) or less, more preferably 15.5×10⁻¹² (1/Pa) or less. The lower limit of the photoelastic coefficient is not particularly restricted, and the photoelastic coefficient closer to 0 is more preferred. In a case where the photoelastic coefficient is within the above range, generation of phase difference due to heat distortion, etc. can be prevented and light leakage can be reduced. The photoelastic coefficient of the optical compensation film is approximately equal to that of the support, is largely affected by the material of the support, and thereby can be controlled within the above range by selecting the material. The support is preferably mainly formed of triacetylcellulose or norbornene to control the photoelastic coefficient more easily though the material of the support will be described in detail hereinafter. Further, when the photoelastic coefficient of the optical compensation film is within the above range and the optically anisotropic layer comprises twist-aligned discotic compound molecules, the generation of the phase difference due to heat distortion, etc. can be reduced. Thus, in the case of using such an optical compensation film in a liquid crystal display, even when the display is driven over a long period of time or driven under a hard condition of a high temperature, the light leakage is hardly generated by variation of the optical properties of the film.

The photoelastic coefficient may be measured by using a measuring apparatus such as ELLIPSOMETER M-150 manufactured by Jasco Corporation.

Materials, producing processes, etc. of the optical compensation film of the invention are described in detail below.

[Support]

The support used in the invention is preferably transparent, and specifically the light transmittance of the support is preferably 80% or more. There are no particular restrictions on the materials of the support, and glass plates, polymer films, etc. may be used as the support. Particularly, the polymer films are preferably used. Examples of polymers for the polymer films include cellulose esters such as cellulose mono- to tri-acylates, norbornene polymers, and polymethyl methacrylates. Commercially available polymer such as norbornene polymers of ARTON and ZEONEX (trade names) may be used for the polymer films. Further, though polycarbonates, polysulfones, etc. are known as polymers that is likely to generate birefringence, also such polymers can be used for the optical film of the invention by modifying them to control the generation of birefringence as described in WO 00/26705.

Among the polymers, preferred are cellulose esters, and more preferred are lower fatty acid esters of cellulose. The lower fatty acid is a fatty acid having at most 6 carbon atoms. The cellulose ester is preferably an acylate with 2 to 4 carbon atoms of cellulose, and particularly preferably a cellulose acetate. Mixed fatty acid esters such as cellulose acetate propionates and cellulose acetate butyrates may be used as the cellulose ester.

The viscosity average polymerization degree (DP) of the cellulose acetate is preferably 250 or more, more preferably 290 or more. It is preferred that the cellulose acetate has a narrow molecular weight distribution of Mw/Mn measured by a gel permeation chromatography, in which Mw is a weight average molecular weight and Mn is a number average molecular weight. Specifically, the value of Mw/Mn is preferably 1.0 to 1.7, more preferably 1.0 to 1.65.

The cellulose acetate preferably has an acetylation degree of 55.0 to 62.5%. The acetylation degree is more preferably 57.0 to 62.0%. The acetylation degree means the amount of connected acetic acid moieties per unit mass of the cellulose. The acetylation degree is obtained by measurement and calculation of ASTM D-817-91 (test method for cellulose acetate, etc.) In the cellulose acetate, generally the hydroxyl groups at the 2-, 3-, and 6-positions of cellulose are not equally replaced, and the substitution degree at the 6-positions is lower. In the cellulose acetate used for the transparent support, the substitution degree at the 6-positions of cellulose is preferably equal to or higher than those at the 2-positions and 3-positions. The ratio of the substitution degree at the 6-positions to the total substitution degrees at the 2-, 3-, and 6-positions is preferably 30 to 40%, more preferably 31 to 40%, most preferably 32 to 40%. The substitution degree at the 6-positions is preferably 0.88 or more.

The acyl groups and methods for synthesizing the cellulose acylate are described in detail in Hatsumei Kyokai Kokai Giho (JIII Journal of Technical Disclosure), No. 2001-1745, Page 9 (published in Mar. 15, 2001, Japan Institute of Invention and Innovation).

It is preferred that the polymer film used as the transparent support contributes to the optical compensation ability, and thus has a preferred retardation.

The preferred retardation value of the transparent support depends on the type and use of the liquid crystal cell using the optical compensation film, and is preferably 0 to 200 nm.

The retardation of the polymer film is generally controlled by a method of applying an external force, such as a stretching method. A retardation increasing agent for controlling the optical anisotropy, a compound for reducing the optical anisotropy, or a wavelength dispersion controlling agent may be added to the polymer film if necessary. It is preferred that an aromatic compound having at least two aromatic rings is used as the retardation increasing agent to control the retardation of the cellulose acylate film. The amount of the aromatic compound is preferably within the range of 0.01 to 20 parts by mass per 100 parts by mass of the cellulose acylate. Two of more aromatic compounds may be used in combination. The aromatic rings of the aromatic compound include aromatic hydrocarbon rings and aromatic heterocycles. Examples of the aromatic compounds include those described in European Patent No. 0911656 A2 and JPA Nos. 2000-111914 and 2000-275434, etc.

Examples of the compounds for reducing the optical anisotropy of the polymer film and the wavelength dispersion controlling agents are illustrated below without intention of restricting the scope of the invention.

Examples of compounds for reducing optical anisotropy

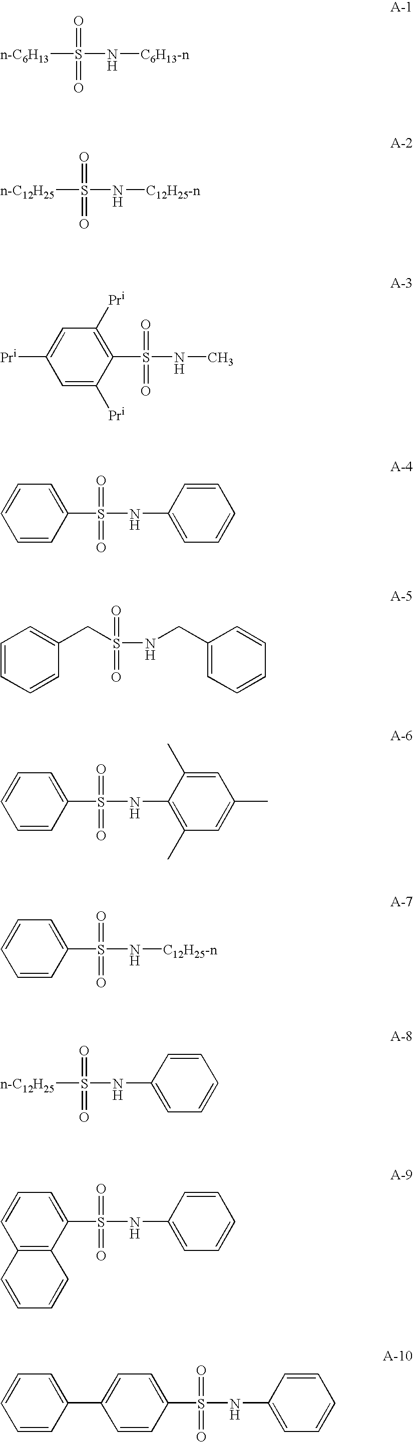

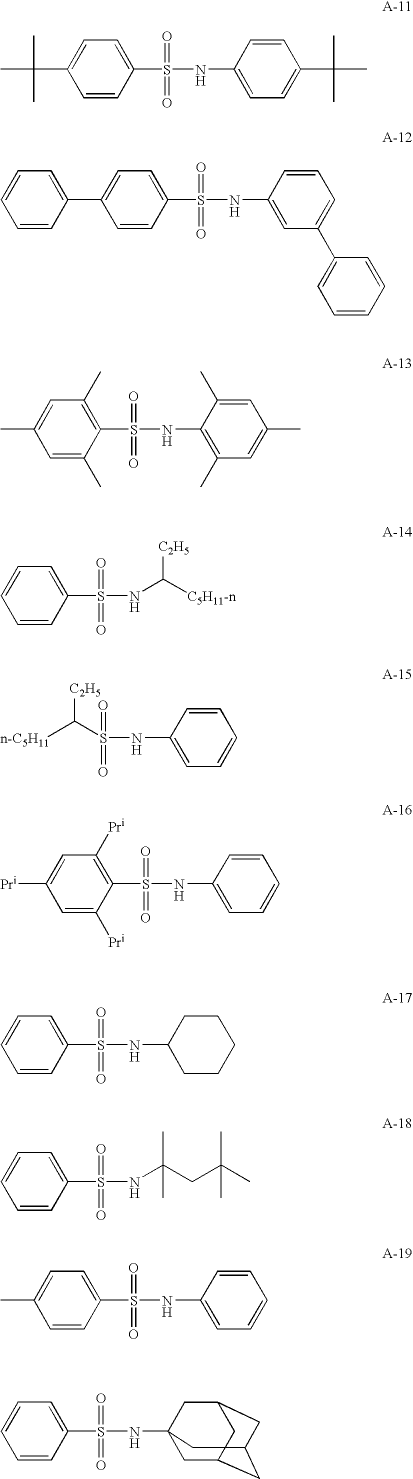

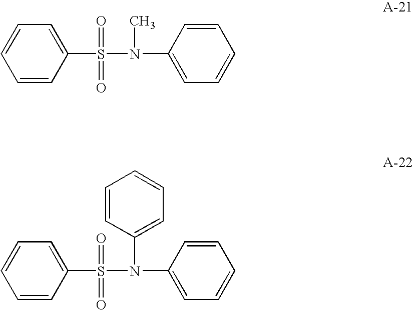

Examples of wavelength dispersion controlling agents

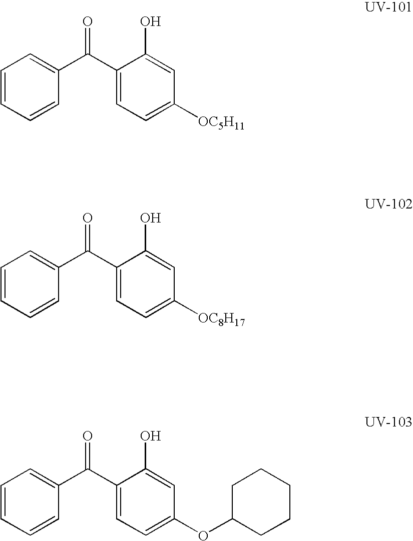

The cellulose acetate film used as the transparent support preferably has a hygroscopic expansion coefficient of 30×10⁻⁵/% RH or less. The hygroscopic expansion coefficient is more preferably 15×10⁻⁵/% RH or less, further preferably 10×10⁻⁵ /% RH or less. The hygroscopic expansion coefficient is generally 1.0×10⁻⁵/% RH or more, though a smaller hygroscopic expansion coefficient is more preferred. The hygroscopic expansion coefficient represents length variation of a sample by changing relative humidity at a constant temperature.

By controlling the hygroscopic expansion coefficient, frame-like increase of the transmittance (the light leakage due to distortion) can be prevented while maintaining the optical compensation function of the optical compensation film.

Measurement of the hygroscopic expansion coefficient is described below. A sample having a width of 5 mm and a length of 20 mm was cut out from a produced polymer film, and hung under conditions of 25° C. and 20% RH(R⁰) by fixing one end of the sample. A 0.5 g weight was attached to the other end of the sample and left for 10 minutes, and the length (L⁰) of the sample was measured. Then, the humidity was changed to 80% RH(R¹) while keeping the temperature at 25° C., and the length (L¹) was measured. The hygroscopic expansion coefficient can be calculated using the following equation. Ten samples of a polymer film are subjected to the measurement to obtain an average value.
Hygroscopic expansion coefficient [/% RH]={(L¹−L⁰)/L⁰}/(R¹−R⁰)

To reduce the dimensional change of the polymer film due to moisture absorption, compounds or fine particles having a hydrophobic group are preferably added. The compound having a hydrophobic group is preferably selected from plasticizers and degradation inhibitors having a hydrophobic group such as an aliphatic group or an aromatic group. The amount of the compound is preferably within the range of 0.01 to 10% by mass based on the resultant solution (dope). The free volume in the polymer film is preferably reduced, and specifically the free volume is small when the residual solvent amount is lower in the film formation by the solvent casting method to be hereinafter described. The film is preferably dried under the condition that the residual solvent amount 0.01 to 1.00% by mass based on the cellulose acetate film.

The above-described additives and other additives for various purposes for the polymer film may be solid or oil, the additives including ultraviolet resistant agents, releasing agents, antistatic agents, degradation inhibitors (such as antioxidants, peroxide decomposing agents, radical inhibitors, metal deactivators, acid scavengers, and amines), infrared absorbents, etc. In a case where the film has a plurality of layers, the layers may contain different types and amounts of the additives. Materials described in Hatsumei Kyokai Kokai Giho No. 2001-1745, Page 16 to 22 are preferably used in the invention. The content of each of the materials is preferably 0.001 to 25% by mass to all the components in the polymer film, though the content is not particularly limited as long as the material can show its function.

[Production of Polymer Film]

The polymer film is preferably produced by a solvent casting method. In the solvent casting method, a solution (dope) prepared by dissolving a polymer material in an organic solvent is used for producing the film. In the solvent casting method, the dope is cast on a drum or a band, and the solvent is evaporated, to form the film. The concentration of the dope is preferably controlled before the casting such that the resulting solid content is 18 to 35%. The surface of the drum or the band is preferably in the mirror finished state.

The dope is preferably cast on the drum or band having a surface temperature of 10° C. or less. The cast dope is preferably air-dried for 2 seconds or more after the casting. The obtained film is peeled off from the drum or band, and it may be further dried by hot air while successively changing the air temperature within the range of 100 to 160° C. to evaporate the residual solvent. This method is described in JPB No. 5-17844. The time between the casting and the peeling can be reduced by using the method. To carry out the method, the dope has to be converted into a gel at the surface temperature of the drum or band at the casting step.

In the casting step, one cellulose acylate solution may be cast into a single layer, and 2 or more cellulose acylate solutions may be co-cast simultaneously and/or successively.

Examples of methods for co-casting two or more cellulose acylate solutions as described above include methods of casting cellulose acylate solutions into layers respectively from a plurality of casting openings formed at some intervals in the moving direction of a support (JPA No. 11-198285, etc.), methods of casting cellulose acylate solutions from two casting openings (JPA No. 6-134933), and methods of enclosing flow of a high-viscosity cellulose acylate solution with a low-viscosity cellulose acylate solution, thereby extruding the solutions simultaneously (JPA No. 56-162617). The invention is not limited to the methods.

The production using the solvent casting method is described in detail in Hatsumei Kyokai Kokai Giho No. 2001-1745, Page 22 to 30, and the steps are classified into dissolution, casting (co-casting), metal support, drying, peeling, stretching, etc.

The thickness of the film used as the support is preferably 15 to 120 μm, more preferably 30 to 80 μm.

[Surface Treatment of Polymer Film]

The polymer film is preferably subjected to a surface treatment. The surface treatments include corona discharge treatments, glow discharge treatments, flame treatments, acid treatments, alkali treatments, and ultraviolet ray irradiation treatments. These treatments are described in detail in Hatsumei Kyokai Kokai Giho No. 2001-1745, Page 30 to 32. Among the treatments, alkali saponification treatments are particularly preferred and remarkably efficient for treating the cellulose acylate film.

The alkali saponification treatment may be carried out by soaking the polymer film in a saponification solution, or by coating the film with a saponification solution, and is preferably carried out by the coating method. Examples of the coating methods include dip coating methods, curtain coating methods, extrusion coating methods, bar coating methods, and E coating method. Examples of alkali saponification solutions include potassium hydroxide solutions and sodium hydroxide solutions, and the normal concentration of the hydroxide ions is preferably 0.1 to 3.0 N. The wetting properties to the transparent support and the temporal stability of the saponification solution can be improved by using a solvent excellent in wetting properties to the film (e.g. isopropyl alcohol, n-butanol, methanol, ethanol), a surfactant, a wetting agent (e.g. diol, glycerin), etc. in the alkali treatment solution. Specific examples thereof include those described in JPA No. 2002-82226 and WO 02/46809.

Instead of or in addition to conducting the surface treatment, an undercoat layer may be formed (JPA No. 7-333433), a single layer method of applying a resin such as a gelatin having a hydrophobic group and a hydrophilic group may be carried out, or a so-called superposition method, which comprises the steps of forming a layer attachable to the polymer film firmly (hereinafter referred to as the first undercoat layer) and forming a layer of a hydrophilic resin such as gelatin attachable to the alignment layer firmly (hereinafter referred to as the second undercoat layer) thereon, may be carried out (JPA No. 11-248940, etc.)

[Optically Anisotropic Layer]

The optical compensation film of the invention comprises the optically anisotropic layer formed of a composition comprising discotic liquid crystalline material. Preferred embodiments of the optically anisotropic layer are described in detail below.

The optically anisotropic layer is preferably designed to compensate a liquid crystal compound in a liquid crystal cell of a liquid crystal display in the black state. The orientation of the liquid crystal compound in the liquid crystal cell in the black state is different depending on the mode of the liquid crystal display. The relation between the orientation of the liquid crystal compound in the liquid crystal cell and the orientation of the compensation film is described in IDW'00, FMC7-2, Page 411 to 414.

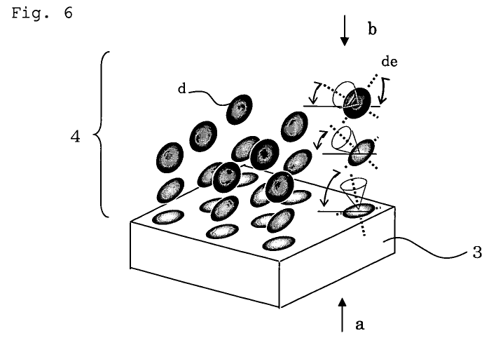

In the optical compensation film according to the first embodiment of the invention, the discotic compound molecules in the optically anisotropic layer are in the hybrid alignment state that the angles between the discotic planes of the discotic compound molecules and the film plane varies in the film thickness direction, and is fixed in the alignment twisted in the thickness direction at the average twist angle φ to satisfy the condition of (3). The alignment state of the discotic compound is schematically shown in FIG. 6. The optical compensation film shown in FIG. 6 according to the invention comprises the transparent support 3 and the optically anisotropic layer 4. In the optically anisotropic layer 4, tilt angles of discotic compound molecules d are each fluctuated within the range of cones, and the molecules are twisted-aligned at the average twist angle φ and fixed in the hybrid alignment state that the tilt angles (angles between the major axes de and the film plane) is increased in the thickness direction from the transparent support interface to the air interface. The molecules are aligned such that the molecules have a twisting direction opposite to the liquid crystal layer in the case of observing the compensation film from the display surface. For example, in a case where the optical compensation film of the invention is disposed between the polarizing film on the display side and the liquid crystal cell such that the optically anisotropic layer faces the liquid crystal cell, the display is observed in the direction of the arrow a from the underside to the upside, and the discotic compound molecules are fixed to the twisted alignment opposite to that of the liquid crystal cell. On the other hand, in a case where the optical compensation film of the invention is disposed between the polarizing film on the back surface side and the liquid crystal cell such that the optically anisotropic layer faces the liquid crystal cell, the display is observed in the direction of the arrow b from the upside to the underside, and the discotic compound molecules are fixed to the twisted alignment opposite to that of the liquid crystal molecules in the liquid crystal cell.

In the first embodiment, preferred β (the mean value of a and b) and preferred average twist angle φ of the optically anisotropic layer are designed to satisfy the conditions of (1) to (3) depending on Rth of the transparent support, the thickness d of the optically anisotropic layer, etc.

The discotic compound is in the hybrid alignment in the optically anisotropic layer, whereby the mean tilt angle between the major axes of the discotic compound molecules (the major axes of the discotic planes) and the film plane is increased or decreased as the distance between the molecules and the transparent support interface is increased in the depth direction of the optically anisotropic layer. The average of the tilt angles is preferably increased along with the distance increase. Further, variation of the mean tilt angle may be continuous increase, continuous decrease, intermittent increase, intermittent decrease, combination of continuous increase and continuous decrease, or intermittent increase and decrease. In the case of the intermittent variation, there is an area having a constant mean tilt angle in the middle in the thickness direction. In the invention, the layer may contain the area having a constant mean tilt angle as long as the mean tilt angle is increased or decreased as a whole. It is preferred that the average of the tilt angles varies continuously.

In the optically anisotropic layer, the discotic compound molecules are in the twisted alignment, whereby the major axes of the discotic compound molecules (the major axes of the discotic planes) are twisted at the average twist angle φ in the thickness direction of the optically anisotropic layer from one interface to the other interface. The twisting of the optically anisotropic layer is preferably 1 pitch or less. The direction of the twisting may be clockwise direction or counterclockwise direction, and is opposite to that of the liquid crystal to be optically compensated in the liquid crystal cell as described above.

Other optical properties of the optically anisotropic layer are not particularly limited, and may be selected as usage. Generally, the in-plane retardation Re of the layer is preferably 10 to 120 nm, more preferably 30 to 90 nm.

The optically anisotropic layer can be formed such that a composition comprising the discotic compound is applied to the transparent support, and heated if necessary. To align the discotic compound into the above-described preferred alignment state, it is preferred that an alignment layer or a material for controlling the alignment such as a chiral agent, a surfactant, and a polymer is used. For example, in the case of using the alignment layer, the alignment direction of the major axes of the discotic compound on the interface of the alignment layer can be controlled by selecting a material for the alignment layer or by selecting a rubbing treatment method. The alignment direction of the major axes (the discotic planes) of the discotic compound on the front side (the air interface) can be controlled by selecting the discotic compound or an additive used in combination therewith. Further, a polymerizable monomer and an initiator for fixing the liquid crystal molecules may be added to the composition for forming the optically anisotropic layer. The alignment variation degree of the major axes of the liquid crystal molecules can be controlled by selecting the liquid crystal and the additive in the above manner.

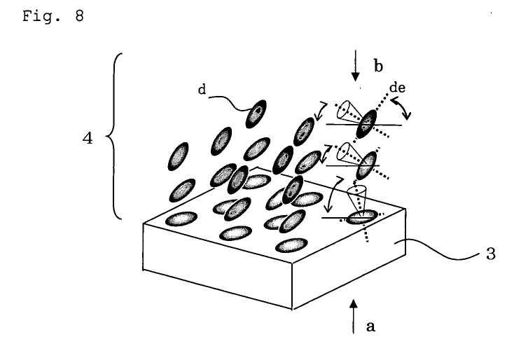

The optical compensation film according to the second embodiment of the invention is schematically shown in FIG. 8. The discotic compound molecules are not twisted in contrast to those of the first embodiment. The optical compensation film shown in FIG. 8 comprises the transparent support 3 and the optically anisotropic layer 4. In the optically anisotropic layer 4, the discotic compound molecules d are fluctuated within the range of cones, and fixed in the hybrid alignment state that the average of the tilt angles (angles between the major axes de and the film plane) is increased in the thickness direction from the transparent support interface to the air interface.

The discotic compound molecules are in the hybrid alignment in the optically anisotropic layer, whereby the mean tilt angle between the major axes of the discotic compound molecules (the major axes of the discotic planes) and the film plane is increased or decreased as the distance between the molecules and the transparent support interface is increased in the depth direction of the optically anisotropic layer. The average of the tilt angles is preferably increased along with the distance increase in the same manner as the first embodiment. Further, variation of the mean tilt angle may be continuous increase, continuous decrease, intermittent increase, intermittent decrease, combination of continuous increase and continuous decrease, or intermittent increase and decrease. In the case of the intermittent variation, there is an area having a constant mean tilt angle in the middle in the thickness direction. In the invention, the layer may contain the area having a constant mean tilt angle as long as the mean tilt angle is increased or decreased as a whole. It is preferred that the average of the tilt angles varies continuously.

Other optical properties of the optically anisotropic layer are not particularly limited, and may be selected as usage. Generally, the in-plane retardation Re of the layer is preferably 0 to 120 nm, more preferably 0 to 80 nm.

The optically anisotropic layer can be formed such that a composition comprising the discotic compound is applied to the transparent support, and heated if necessary. To align the discotic compound into the above-described preferred alignment state, it is preferred that an alignment layer or a material for controlling the alignment such as a surfactant and a polymer is used. Particularly, in view of controlling the mean tilt angle of the discotic compound at 40 deg. or more, generally a so-called homeotropic alignment agent for raising the liquid crystal from the substrate is used and the angle is exactly adjusted by selecting the rubbing condition to obtain a desired alignment state. The alignment direction of the discotic planes of the discotic compound molecules on the front side (the air interface) can be controlled by selecting the discotic compound or an additive used in combination therewith. Examples of the additives for use in combination with the discotic compound include plasticizers, surfactants, polymerizable monomers, and polymers. The alignment variation degree of the discotic planes can be controlled by selecting the liquid crystal molecule and the additive in the above manner.

[Discotic Compound]

Examples of the discotic compounds usable in the invention include benzene derivatives described in C. Destrade, et al., Mol. Cryst., Vol. 71, Page 111 (1981), truxene derivatives described in C. Destrade, et al., Mol. Cryst. Vol. 122, Page 141 (1985) and Physics Lett., A, Vol. 78, Page 82 (1990), cyclohexane derivatives describedinB. Kohne, et al., Angew. Chem., Vol. 96, Page 70 (1984), and azacrown- or phenylacetylene-based macrocycles described in J. M. Lehn, et al., J. Chem. Commun., Page 1794 (1985), J. Zhang, et al., J. Am. Chem. Soc., Vol. 116, Page 2655 (1994).

The examples of the discotic compounds include liquid crystalline compounds having a core and radial side chains of straight alkyl, alkoxy, or substituted benzoyloxy groups. The discotic compound is preferably such a compound that exhibits a rotation symmetry in the state of a molecule or a molecular assembly to be in an alignment. In the optically anisotropic layer, the discotic compound is not required to exhibit liquid crystalline properties finally. For example, the discotic compound may be a low-molecular discotic compound having a heat- or light-responsive group, which shows no liquid crystalline properties after the compound is aligned into a predetermined state, polymerized or crosslinked by applying heat or light, and fixed to the alignment state. Preferred examples of the discotic compounds include those described in JPA No. 8-50206. The polymerization of the discotic compound is described in JPA No. 8-27284.

In the case of fixing the discotic compound by polymerization, a polymerizable group is connected to a discotic core of the discotic compound as a substituent. It is preferred that the discotic core and the polymerizable group are connected by a linking group, whereby the alignment is maintained after the polymerization. Examples of such discotic compounds include compounds described in JPA No. 2000-155216, Paragraph 0151 to 0168, etc. The phase transition temperature of the discotic compound between the discotic nematic liquid crystalline phase and the solid phase is preferably 70 to 300° C., more preferably 70 to 170° C.

[Chiral Agent]

In the first embodiment of the invention, the optically anisotropic layer may have a twist structure to cancel the retardation of the liquid crystal layer. In this case, it is preferable to add a chiral agent to the optically anisotropic layer. The chiral agent is generally an optically active compound having an asymmetric carbon atom. The chiral agent may be selected from various natural or synthetic compounds having an asymmetric carbon atom. The chiral agent is particularly preferably a discotic compound having a structure provided by introducing an asymmetric carbon atom to a linking group (R) of a discotic liquid crystal molecule described in JPA No. 8-50206. Specifically, the asymmetric carbon atom is introduced to AL (an alkylene or alkenylene group) in the linking group (R). Preferred examples of AL* containing an asymmetric carbon atom are described in JPA No. 2001-100035, Paragraph 0033 to 0035. The amount of the chiral agent is desirably such that the chiral agent twists the structure at an angle of (21.3×d−39.8) degree with a margin of error of 30%, preferably 20%, more preferably 15%, in which d (μm) is the thickness of the discotic compound layer. The degree of the twisting may be determined by using a polarization microscope from extinction angle of extinction axis from rubbing axis in the state of the crossed nicols. The term “extinction” means not only that the transmitted light is strictly zero, but also that the transmitted light is minimum. When the twisted alignment is in the state shown in the schematic view of FIG. 4, the extinction angle is 60 to 80% of the practical twist angle.

The chiral agent is described as an example of causing retardation, and the invention is not limited thereto.

[Additive for Optically Anisotropic Layer]

The composition for forming the optically anisotropic layer may comprise various additives such as the chiral agent in addition to the discotic compound. Examples of the additives include plasticizers, surfactants, polymerizable monomers, etc. These additives contribute to improvement of uniformity of the layer, strength of the layer, or the alignment of the liquid crystal molecules, etc. It is preferred that the additives have compatibility to the liquid crystal molecules, and can contribute to the variation of the tilt angles of the liquid crystal molecules or do not inhibit the alignment. Examples of the surfactants include the following fluorine-containing surfactant.

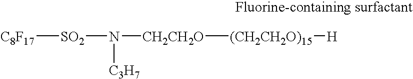

The polymerizable monomer may be a radical or cationic polymerizable compound. The polymerizable monomer is preferably a polyfunctional, radical polymerizable monomer, and is preferably copolymerizable with the above-described liquid crystal compound having a polymerizable group. Examples of the monomers include those described in JPA No. 2002-296423, Paragraph 0018 to 0020. The ratio of the monomer to the discotic compound is generally within the range of 1 to 50% by mass, preferably within the range of 5 to 30% by mass.

The surfactant may be a known compound, and is particularly preferably a fluorine compound. Specific examples thereof include compounds described in JPA No. 2001-330725, Paragraph 0028 to 0056.

It is preferred that the polymer used in combination with the discotic compound can generate the variation of the tilt angles.

The polymer may be a cellulose ester, and preferred examples thereof include those described in JPA No. 2000-155216, Paragraph 0178. The mass ratio of the polymer to the liquid crystal molecules is preferably within the range of 0.1 to 10% by mass, more preferably within the range of 0.1 to 8% by mass, from the viewpoint of not inhibiting the alignment of the liquid crystal molecules.

[Formation of Optically Anisotropic Layer]

The optically anisotropic layer may be formed by applying a coating liquid of the discotic compound, which contains the additives if necessary, to an alignment layer.

The solvent for preparing the coating liquid is preferably an organic solvent. Examples of the organic solvents include amides such as N,N-dimethylformamide; sulfoxides such as dimethylsulfoxide; heterocyclic compounds such as pyridine; hydrocarbons such as benzene and hexane; alkyl halides such as chloroform, dichloromethane, and tetrachloroethane; esters such as methyl acetate and butyl acetate; ketones such as acetone and methyl ethyl ketone; and ethers such as tetrahydrofuran and 1,2-dimethoxyethane. Preferred organic solvents include alkyl halides and ketones. Two or more types of organic solvents may be used in combination.

The coating liquid may be applied by a known method such as a wire-bar coating method, an extrusion coating method, a direct gravure coating method, a reverse gravure coating method, and a die coating method.

[Fixation of Alignment of Liquid Crystal Molecules]

The aligned liquid crystal molecules may be fixed in the alignment state. The fixation is preferably achieved by polymerization. The polymerization may be heat polymerization using a heat polymerization initiator or photopolymerization using a photopolymerization initiator, and is preferably photopolymerization.

Examples of the photopolymerization initiators include α-carbonyl compounds described in U.S. Pat. Nos. 2,367,661 and 2,367,670; acyloin ethers described in U.S. Pat. No. 2,448,828; α-hydrocarbon-substituted, aromatic acyloin compounds described in U.S. Pat. No. 2,722,512; polynuclear quinone compounds described in U.S. Pat. Nos. 3,046,127 and 2,951,758; combinations of triarylimidazole dimers and p-aminophenyl ketone described in U.S. Pat. No. 3,549,367; acridine compounds and phenazine compounds described in JPA No. 60-105667 and U.S. Pat. No. 4,239,850; and oxadiazole compounds described in U.S. Pat. No. 4,212,970.

The mass ratio of the photopolymerization initiator to the solid content of the coating liquid is preferably 0.01 to 20% by mass, more preferably 0.5 to 5% by mass.

In the photopolymerization, the liquid crystal molecules are preferably irradiated with ultraviolet ray.

The irradiation energy is preferably within the range of 20 mJ/cm² to 50 J/cm², more preferably within the range of 20 to 5000 mJ/cm², further preferably within the range of 100 to 800 mJ/cm². The irradiation may be carried out under a heating condition to accelerate the photopolymerization.

A protective layer may be formed on the optically anisotropic layer.

[Alignment Layer]

The alignment layer has a function of determining the alignment direction of the discotic compound. It is preferred that the alignment layer is used for aligning the discotic compound to the above state, though the alignment layer is not necessarily an essential component of the invention and the function thereof may be compensated by fixing the alignment state after aligning the liquid crystalline molecules. Thus, the optical compensation film of the invention may be produced by transferring only the optically anisotropic layer on the upside of the alignment layer with a fixed alignment state to the transparent support.

The alignment layer may be formed by a method of rubbing an organic compound (preferably a polymer), oblique-depositing an inorganic compound, forming a layer having microgrooves, or accumulating an organic compound (e.g., ω-tricosanic acid, dioctadecylmethylammonium chloride, methyl stearate) by Langmuir-Blodgett method to form an LB film. Further, the alignment layer may be a known one formed by applying an electric field, a magnetic field, or a light irradiation to obtain the alignment function.

The alignment layer is preferably formed by subjecting a polymer to the rubbing treatment. The polymer for the alignment layer essentially has a structure with a function of aligning the liquid crystal molecules. In addition, in the invention, it is preferred that a side chain having a crosslinking functional group such as a double bond group is connected to the main chain of the polymer, or a crosslinking functional group having a function of aligning the liquid crystal molecules is introduced to the side chain of the polymer.

The polymer for the alignment layer may be a polymer which can be crosslinked singly or by a crosslinking agent, and a plurality of the polymers may be used in combination.

Examples of the polymers include methacrylate copolymers, styrene copolymers, polyolefins, polyvinyl alcohols, modified polyvinyl alcohols, poly(N-methylolacrylamide) s, polyesters, polyimides, vinyl acetate copolymers, carboxymethylcelluloses, and polycarbonates, described in JPA No. 8-338913, Paragraph 0022, etc. A silane coupling agent may be used as the polymer. Preferred polymers include water-soluble polymers (e.g., poly(N-methylolacrylamide)s), carboxymethylcelluloses, gelatins, polyvinyl alcohols, and modified polyvinyl alcohols, more preferred polymers include gelatins, polyvinyl alcohols, and modified polyvinyl alcohols, and the most preferred polymers include polyvinyl alcohols and modified polyvinyl alcohols. A combination of two unmodified or modified polyvinyl alcohols having different polymerization degrees is particularly preferably used.

The saponification degree of the polyvinyl alcohol is preferably 70 to 100%, more preferably 80 to 100%. The polymerization degree of the polyvinyl alcohol is preferably 100 to 5,000.

The side chain having the function of aligning the liquid crystal molecules generally contains a hydrophobic group as a functional group. Specifically the type of the functional group is selected based on the type of the liquid crystal molecules and the desired alignment state.

For example, a modification group of the modified polyvinyl alcohol may be introduced by copolymerization modification, chain transfer modification, or block polymerization modification. Examples of the modification groups include hydrophilic groups (e.g., carboxylic acid groups, sulfonic acid groups, phosphonic acid groups, amino groups, ammonium groups, amide groups, thiol groups), hydrocarbon groups having 10 to 100 carbon atoms, fluorine-substituted hydrocarbon groups, thioether groups, polymerizable groups (e.g., unsaturated polymerizable groups, epoxy groups, aziridinyl groups), alkoxysilyl groups (e.g., trialkoxy, dialkoxy, or monoalkoxy-silyl groups), etc. Specific examples of the modified polyvinyl alcohol compounds include those described in JPA No. 2000-155216, Paragraph 0022 to 0145, JPA No. 2002-62426, Paragraph 0018 to 0022, etc.

In the case of connecting a side chain having a crosslinking functional group to the main chain of the polymer for the alignment layer, or introducing a crosslinking functional group to the side chain having the function of aligning the liquid crystal molecules, the polymer in the alignment layer and the polyfunctional monomer in the optically anisotropic layer can be copolymerized. As a result, strong covalent bonds are formed not only between the polyfunctional monomers, but also between the polymers in the alignment layer and between the polyfunctional monomer and the polymer in the alignment layer. Thus, the strength of the optical compensation film can be remarkably improved by introducing the crosslinking functional group to the alignment layer polymer.

The crosslinking functional group in the alignment layer polymer preferably has a polymerizable group as well as the polyfunctional monomer. Specific examples thereof include those described in JPA No. 2000-155216, Paragraph 0080 to 0100.

The alignment layer polymer may be crosslinked by the crosslinking agent without using the above crosslinking functional group.

Examples of the crosslinking agents include aldehydes, N-methylol compounds, dioxane derivatives, compounds for activating a carboxyl group, active vinyl compounds, active halogen compounds, isoxazoles, and dialdehyde starchs. Two or more types of the crosslinking agents may be used in combination. Specific examples thereof include compounds described in JPA No. 2002-62426, Paragraph 0023 to 0024, etc. The crosslinking agent is preferably a high-reactive aldehyde, particularly preferably glutaraldehyde.

The ratio of the crosslinking agent to the polymer is preferably 0.1 to 20% by mass, more preferably 0.5 to 15% by mass. The content of the unreacted crosslinking agent remaining in the alignment layer is preferably 1.0% by mass or less, more preferably 0.5% by mass or less. The durability of the alignment layer is sufficiently improved by controlling the amounts in this manner such that reticulation is not generated even when the alignment layer is used in a liquid crystal display or left under a high-temperature high-humidity environment over a long period of time.

The alignment layer may be formed by the steps of applying a coating liquid containing materials such as the polymer and the crosslinking agent to the transparent support, heat-drying (crosslinking) the applied liquid, and subjecting it to a rubbing treatment. The crosslinking reaction may be carried out at any time after applying the liquid to the transparent support as described above. In the case of using the water-soluble polymer such as polyvinyl alcohol as the material for the alignment layer, the coating liquid preferably contains a mixed solvent of water and an organic solvent having a defoaming property such as methanol. The mass ratio of water:methanol is preferably 0:100 to 99:1, more preferably 0:100 to 91:9. Thus foaming of the liquid is prevented, whereby defects of the surfaces of the alignment layer and the optically anisotropic layer are extremely reduced.

The coating method for forming the alignment layer is preferably a spin coating method, a dip coating method, a curtain coating method, an extrusion coating method, a rod coating method, or a roll coating method, particularly preferably a rod coating method. The thickness of the dried coating is preferably 0.1 to 10 μm. The temperature for the heat drying may be 20 to 110° C. The temperature is preferably 60 to 100° C., particularly preferably 80 to 100° C., to form a sufficiently crosslinked structure. The drying time may be 1 minute to 36 hours, and is preferably 1 minute to 30 minutes. The pH value of the coating liquid is preferably controlled appropriately for the crosslinking agent, and it is 4.5 to 5.5 and particularly 5 in the case of using glutaraldehyde.

The alignment layer may be formed on the transparent support, or on an undercoat layer formed on the transparent support optionally. The alignment layer may be formed by rubbing the polymer layer after the crosslinking as described above.

The rubbing treatment may be achieved by utilizing a method that is widely used for a liquid crystal alignment treatment of LCD. Thus, the alignment layer may be formed by rubbing the surface of the alignment layer with paper, gauze, felt, rubber, nylon, polyester fiber, etc. in a constant direction to obtain the alignment. The rubbing treatment is generally carried out by rubbing the layer several times with a cloth woven from fibers with uniform length and width, etc.

Next the liquid crystal molecules in the optically anisotropic layer formed on the alignment layer are aligned by utilizing the function of the alignment layer. Then, if necessary, the polymer in the alignment layer and the polyfunctional monomer in the optically anisotropic layer may be reacted, or the polymer may be crosslinked using the crosslinking agent.

The thickness of the alignment layer is preferably within the range of 0.1 to 10 μm.

[Ellipsoidal Polarizing Plate]

In the case of using the optical compensation film of the invention for compensating a liquid crystal cell, the optical compensation film is inserted, stacked, and optically attached between a polarizing film and a liquid crystal layer. Thus, it is advantageous that the optical compensation film is preliminarily attached to the polarizing film to form an ellipsoidal polarizing plate. The optical compensation film of the invention may be bonded to the polarizing plate, and may be used as a protective film for the polarizing film. In the case of using the optical compensation film as the protective film for the polarizing film, the liquid crystal display can be thinned.

It is preferred that the optically anisotropic layer is formed by directly applying a composition containing the liquid crystal molecules to the surface of the polarizing film, or formed by utilizing the alignment layer from the liquid crystal molecules. Specifically, the optically anisotropic layer may be formed by applying the above-described coating liquid for the optically anisotropic layer to the polarizing film. As a result, a thin polarizing plate, which generates only a smaller stress (distortion×cross sectional area×elasticity) due to the dimensional change of the polarizing film, is produced without using a polymer film between the polarizing film and the optically anisotropic layer. When the polarizing plate according to the invention is attached to a large liquid crystal display, the display can provide an image with high display qualities without defects of light leakage, etc.

[Polarizing Film]

The polarizing film used in the invention is preferably a coating type polarizing film such as those of Optiva Inc., or a polarizing film comprising iodine or a dichroic dye in combination with a binder. In the polarizing film, the iodine and dichroic dye are aligned in the binder to show the polarizing property. It is preferred that the iodine and dichroic dye are aligned along the binder molecules, or the dichroic dye is self-assembled as liquid crystals and aligned in one direction. Now commercially available polarizers are generally produced by soaking a stretched polymer in a solution of the iodine or dichroic dye in a bath, thereby penetrating the iodine or dichroic dye into the binder.

In commercially available polarizing films, the iodine or the dichroic dye is distributed in a region within a distance of approximately 4 μm (total 8 μm on both sides) from the polymer surface. The polarizing film used in the invention preferably has a thickness of 10 μm or more to obtain a sufficient polarizing performance. The degree of the penetration can be controlled by selecting the concentration of the solution of the iodine or the dichroic dye, the temperature of the bath, or the soaking time.

The thickness of the binder is preferably at least 10 μm as described above. From the viewpoint of the light leakage of the liquid crystal display, the smaller the thickness is, the better. The thickness is preferably equal to or less than thickness of commercially available polarizing plates (approximately 30 μm), more preferably 25 μm or less, further preferably 20 μm or less. When the thickness is 20 μm or less, the light leakage is not observed in a 17-inch liquid crystal display.

The binder of the polarizing film may be crosslinked. A polymer that can be crosslinked per se may be used for the crosslinked binder. The polarizing film may be formed by a reaction of a polymer having a functional group or a binder prepared by introducing a functional group to a polymer under a light, heat, or a pH variation. A crosslinking agent may be used to introduce a crosslinked structure to the polymer. The crosslinking is generally carried out by heating after the coating liquid containing the polymer or the mixture of the polymer and the crosslinking agent is applied to the transparent support. The crosslinking may be carried out at any time in the production of the final product of the polarizing plate because only the final product needs to have a sufficient durability.

The binder of the polarizing film may be a polymer capable of being crosslinked per se, or a polymer capable of being crosslinked by a crosslinking agent. Examples of the polymers include those of the alignment layer. The polymer is most preferably a polyvinyl alcohol or a modified polyvinyl alcohol. The modified polyvinyl alcohol is described in JPA Nos. 8-338913, 9-152509, and 9-316127. The polyvinyl alcohols and the modified polyvinyl alcohols may be used in combination of two or more.

It is preferred that the ratio of the added crosslinking agent to the binder is 0.1 to 20% by mass from the viewpoint of improving the alignment of the polarizer and the resistance to moisture and heat of the polarizing film.

The alignment layer contains a certain amount of the unreacted crosslinking agent even after the crosslinking reaction. The mass ratio of the residual crosslinking agent to the alignment layer is preferably 1.0% by mass or less, more preferably 0.5% by mass or less. Thus, the polarization degree is not reduced even when the polarizing film is incorporated into a liquid crystal display and is used or left under a high-temperature high-humidity environment over a long period of time.

The crosslinking agent is described in U.S. Reissue Pat. No. 23297. Further, also a boron compound such as boric acid and borax may be used as the crosslinking agent.

As the dichroic dye, azo dyes, stilbene dyes, pyrazolone dyes, triphenylmethane dyes, quinoline dyes, oxazine dyes, thiazine dyes, and anthraquinone dyes may be used. The dichroic dye is preferably water-soluble. The dichroic dye preferably has a hydrophilic substituent such as sulfo, amino, and hydroxyl groups. Examples of the dichroic dyes include compounds described in Hatsumei Kyokai Kokai Giho (JIII Journal of Technical Disclosure), No. 2001-1745, Page 58 (published in Mar. 15, 2001).

In view of increasing the contrast ratio of the liquid crystal display, it is preferable that the polarizing plate has a higher transmittance and a higher polarization degree. The transmittance of the polarizing plate at the wavelength of 550 nm is preferably within the range of 30 to 50%, more preferably within the range of 35 to 50%, most preferably within the range of 40 to 50%. The polarization degree at the wavelength of 550 nm is preferably within the range of 90 to 100%, more preferably within the range of 95 to 100%, most preferably within the range of 99 to 100%.

[Production of Ellipsoidal Polarizing Plate]

From the viewpoint of yield, it is preferred that the polarizing film is colorized by the iodine or the dichroic dye after the binder is stretched at a tilt angle of 10 to 80 degrees against the longitudinal direction (MD direction) of the polarizing film (a stretching method), or is rubbed (a rubbing method). The stretching is preferably carried out such that the tilt angle is equal to the angle of the transmission axis of 2 polarizing plates bonded on the both sides of the liquid crystal cell of LCD to the transverse or longitudinal direction of the liquid crystal cell. The tilt angle is generally 45°. However, transmission-, reflection-, or semi-transmission-type LCDs where the tilt angle is not 45° have been developed recently, whereby it is preferred that the stretching direction can be freely controlled depending on the LCDs.

In the stretching method, the stretch ratio is preferably 2.5 to 30.0 times, more preferably 3.0 to 10.0 times. The stretching may be carried out by dry stretching in the air. Further, the binder may be soaked in water and stretched by wet stretching. The stretch ratio in the dry stretching is preferably 2.5 to 5.0 times, and the stretch ratio in the wet stretching is preferably 3.0 to 10.0 times. The stretching including oblique stretching may be carried out several times, so that the binder is stretched more uniformly even in the case of high-ratio stretching. The binder may be slightly stretched transversely or longitudinally to prevent shrinkage in the width direction before the oblique stretching. In the stretching method, tentering in the left direction and that in the right direction may be carried out in the different stages in biaxial stretching. Common biaxial stretching methods for forming films may be used in the invention. In the biaxial stretching, the binder film is stretched leftward and rightward at different speeds, whereby the left part and the right part of the binder film need to have different thicknesses before the stretching. In the case of using the casting method for forming the film, the flow rates of the binder solution to the left and right may be differentiated by tapering the die.

In the rubbing method, common rubbing treatments for aligning liquid crystals of LCDs may be used. Thus, the surface of the film may be rubbed with paper, gauze, felt, rubber, nylon, polyester fiber, etc. in a constant direction to obtain the alignment. The rubbing treatment is generally carried out by rubbing the film several times with a cloth woven from fibers with uniform length and width. In the rubbing, a rubbing roll having 30 μm or less of circularity, cylindricity, and deflection (eccentricity) is preferably used. The lap angle of the film to the rubbing roll is preferably 0.1 to 90°. The film may be wound around the roll at 360° or more to achieve a stable rubbing treatment as described in JPA No. 8-160430. In the case of rubbing a long film, the film is preferably transported at a rate of 1 to 100 m/min under a constant tensile force by a transport apparatus. The rubbing roll is preferably rotatable horizontally to the film transport direction to control the rubbing angle. It is preferred that the rubbing angle is appropriately selected within the range of 0 to 60°. In the case of using the film in liquid crystal displays, the rubbing angle is preferably 40 to 50°, particularly preferably 45°.

Then, the optical compensation film of the invention is put on the surface of the polarizing film. The reverse surface of the transparent support, which does not have the optically anisotropic layer, is preferably put on the polarizing film. The optical compensation film may be bonded to the polarizing film using an adhesive. Examples of the adhesives include polyvinyl alcohol resins (including modified polyvinyl alcohol resins modified by an acetoacetyl group, a sulfonic acid group, a carboxyl group, or an oxyalkylene group) and aqueous boron compound solutions. The adhesive is preferably the polyvinyl alcohol resin. The polarizing film and the optical compensation film may be bonded by the steps of applying the adhesive to the polarizing film and/or the optical compensation film to form an adhesive layer, superposing them, and applying heat or pressure if necessary. The dry thickness of the adhesive layer is preferably within the range of 0.01 to 10 μm, particularly preferably within the range of 0.05 to 5 μm.

The optical compensation film of the invention may be put on one surface of the polarizing film, while another polymer film may be put on the other surface of the polarizing film. The polymer film preferably acts as a protective film for the polarizing film. Further, the polymer film preferably has an antireflection film having antifouling property and excoriation resistance as the outermost layer. The antireflection film may be selected from known ones.

[Liquid Crystal Display]

The optical compensation film of the invention is preferably used for optically compensating a liquid crystal cell using liquid crystal in the twisted alignment, such as a TN mode liquid crystal cell.

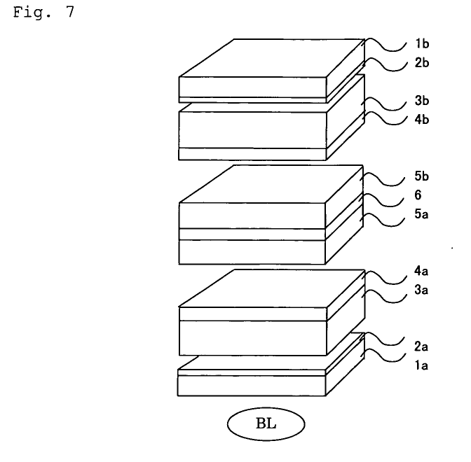

FIG. 7 is a schematic view showing an example of basic structure of a transmission type liquid crystal display having the optical compensation film of the invention.

The transmission type liquid crystal display shown in FIG. 7 comprises a transparent protective film (1a), a polarizing film (2a), a transparent support (3a), an optically anisotropic layer (4a), a lower substrate (5a) of the liquid crystal cell, a rod-like liquid crystal layer (6), an upper substrate (5b) of the liquid crystal cell, an optically anisotropic layer (4b), a transparent support (3b), a polarizing film (2b), and a transparent protective film (1b) in this order from a backlight BL. The transparent supports and the optically anisotropic layers (3a, 4a, 4b, and 3b) form the optical compensation film according to the invention. The transparent protective films, the polarizing films, the transparent supports, and the optically anisotropic layers (1a to 4a and 4b to 1b) form the ellipsoidal polarizing plate according to the invention.

TN mode liquid crystal cells have been most widely used in color TFT liquid crystal displays, and are described in many references.

This embodiment will be explained with an example of using a nematic liquid crystal having a positive dielectric anisotropy. A liquid crystal having a refractive index anisotropy Δn of approximately 0.0854 (589 nm, 20° C.) and a dielectric anisotropy Δε of approximately +8.5 is enclosed between the upper and lower substrates 6a, 6b. The product Δn·d of the thickness d (μm) of the liquid crystal layer and the refractive index anisotropy Δn is preferably 0.2 to 0.5 μm. The alignment of the liquid crystal layer can be controlled by selecting surface properties and rubbing axes of alignment layers formed on the inner surface of the upper and lower substrates 6a, 6b. The director representing the alignment direction of the liquid crystal molecules, the tilt angle, is preferably about 3°. The rubbing directions of the upper and lower substrates 6a and 6b are perpendicular to each other, and the tilt angle can be controlled by selecting the strength and number of the rubbing. The alignment layers are preferably formed by applying and burning a polyimide. The twist angle of the liquid crystal layer depends on the angle between the rubbing directions of the upper and lower substrates and a chiral agent added to the liquid crystal. For example, a chiral agent with a pitch of about 60 μm is preferably added to control the twist angle at 90°. The thickness d of the liquid crystal layer may be approximately 5 μm. The liquid crystal material LC used therein is not particularly limited as long as it is nematic. The driving voltage is reduced as the dielectric anisotropy Δε is larger. When the refractive index anisotropy Δn is smaller, the thickness (the gap) of the liquid crystal layer can be increased, and the unevenness of the gap can be reduced. Further, as Δn is increased, the cell gap can be reduced to achieve high-speed response. The liquid crystal is generally twisted clockwise from observer's viewpoint from the light source to the display, and the optimum value of the twist angle is about 90° (85° to 95°). Since the luminance at the white state in high and the luminance at the black state is low under the condition, the display which is bright and high in contrast can be obtained.

The polarizing axis of the upper polarizing film 2b is approximately perpendicular to the polarizing axis of the lower polarizing film 2a, the polarizing axis of the upper polarizing film 2b is approximately perpendicular to the rubbing direction of the upper substrate 6b, and the polarizing axis of the lower polarizing film 2a is approximately perpendicular to the rubbing direction of the lower substrate 6a. A transparent electrode (not shown) is formed on the inner surface of the alignment layer disposed on each of the upper and lower substrates 6b and 6a. In the non-driving state where a driving voltage is not applied to the electrodes, the liquid crystal molecules in the liquid crystal cell are aligned approximately parallel to the substrate, so that a light passes through the liquid crystal panel along the twist structure of the liquid crystal molecules and emerges such that the polarization plane rotates 90 degrees. Thus, the liquid crystal display performs white display in the non-driving state. On the other hand, in the driving state, the liquid crystal molecules are aligned at an angle to the substrate, so that a light passes through the lower polarizing film 2a and then through the liquid crystal layer 7 with keeping the polarization, and blocked by the polarizing film 2b. Thus, the liquid crystal display performs black display in the driving state. The liquid crystal display employs the optical compensation film of the invention, whereby the grayscale inversion depending on the observation direction is reduced and the viewing angle is improved.

The above-described preferred values are those in the case of the transmission mode, and the preferred value of Δn·d in the case of reflection mode is about half of the above value because light path in the liquid crystal cell is doubled. Further, the preferred value of the twist angle is 30° to 70°.

The structure of the liquid crystal display of the invention is not limited to FIG. 7, and the display may have another component. For example, a color filter may be disposed between the liquid crystal cell and the polarizing film. A backlight using a light source such as a cold or hot cathode fluorescent tube, a light emitting diode, a field emission device, and an electroluminescent device may be disposed in the liquid crystal display. The liquid crystal display of the invention may be a semi-transmission type display having a transmission part and a reflection part for transmission mode and reflection mode in 1 pixel.

The liquid crystal display of the invention may be a direct view type, projection type, or optical modulation type display. The invention is particularly efficiently applied to an active matrix liquid crystal displays using 3- or 2-terminal semiconductor elements such as TFT and MIM. The invention may be efficiently applied also to a passive matrix liquid crystal displays.

### EXAMPLES

The present invention will be explained more specifically with reference to Examples. Materials, reagents, ratios, procedures, etc. used in Examples may be changed without departing from the scope of the invention. Thus, the scope of the invention is not limited to the following Examples.

### Example 1

### Optical Compensation Film of First Embodiment

(Polymer Substrate)

An 80 μm thick triacetylcellulose film FUJI TAC TD-80U (trade name) manufactured by Fuji Photo Film Co., Ltd. was used as a transparent support.

The transparent support was subjected to a measurement using an automatic birefringence meter KOBRA 21ADH (manufactured by Oji Scientific Instruments). As a result, the transparent support had Re(590) of 2 nm and Rth(590) of 41 nm.

(Production of Undercoat Layer)

A coating liquid having the following formulation was applied to the cellulose acetate film at 28 ml/m² and dried, thereby forming a 0.1-μm-thick gelatin layer (undercoat layer), to obtain a polymer substrate PK-1.

Formulation of undercoat layer coating liquid

| | | |
|---|---|---|
| Gelatin | 0.542 | parts by mass |
| Formaldehyde | 0.136 | parts by mass |
| Salicylic acid | 0.160 | parts by mass |
| Acetone | 39.1 | parts by mass |
| Methanol | 15.8 | parts by mass |
| Methylene chloride | 40.6 | parts by mass |
| Water | 1.2 | parts by mass |

An alignment layer coating liquid having the following formulation was applied to PK-1 at 28 ml/m² by a #16 wire-bar coater. The applied liquid was dried by hot air having a temperature of 60° C. for 60 seconds, and further dried by hot air having a temperature of 90° C. for 150 seconds, to form a layer.

(Formulation of Alignment Layer Coating Liquid)

| | | |
|---|---|---|
| Following modified polyvinyl alcohol | 10 | parts by mass |
| Water | 371 | parts by mass |
| Methanol | 119 | parts by mass |
| Glutaraldehyde (crosslinking agent) | 0.5 | parts by mass |

Modified polyvinyl alcohol

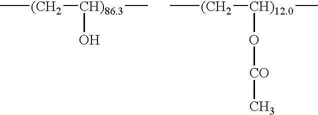

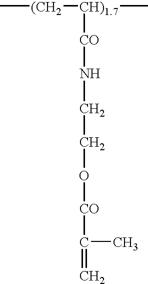

The layer was rubbed in the direction of the retardation axis of the polymer substrate PK-1 to obtain an alignment layer.

(Formation of Optically Anisotropic Layer)

41.01 kg of the following discotic compound (A), 4.06 kg of an ethylene oxide-modified trimethylolpropane triacrylate V#360 available from Osaka Organic Chemical Industry Ltd., 0.35 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., 0.31 kg of a fluorine-containing surfactant, and 0.29 kg of a chiral agent for twisting the discotic compound to form in-plane retardation were dissolved in 102 kg of methyl ethyl ketone to obtain a coating liquid. The coating liquid was continuously applied to the alignment layer by a #4.0 wire bar, and heated at 130° C. for 2 minutes to align the discotic compound.

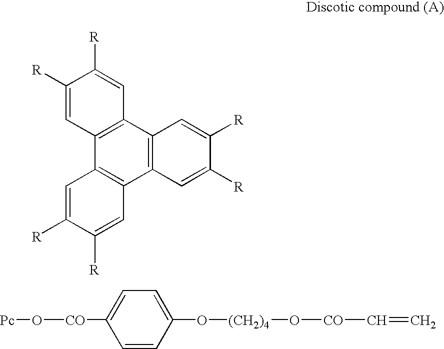

Then, the resultant laminate was irradiated with UV at 100° C. for 1 minute by a 120 W/cm high-pressure mercury vapor lamp to polymerize the discotic compound, and was cooled to the room temperature. Thus an optical compensation film KH-1 having an optically anisotropic layer was produced. The formed optically anisotropic layer had a thickness of 2.6 μm. Retardation of only the optically anisotropic layer was 46 nm at a wavelength of 590 nm. Further, the mean value β of the averages a and b of the angles between the interfaces and the major axes (the discotic planes) of the discotic molecules was 38°. As a result of observing only an optically anisotropic layer prepared separately in crossed nicols alignment by a polarization microscope, the discotic molecules were twisted counterclockwise observed from the air interface from the transparent support to the air, the average twist angle φ obtained from the extinction was 15.6°. The polarizing plate was turned into the crossed nicols state, and unevenness of the obtained optical compensation film was evaluated. As a result, unevenness was not detected by observation from the front and from the direction at 60° against the normal line.

Table 1 shows main properties of the transparent support and the optically anisotropic layer of the optical compensation film KH-1, and d(Rth), Rth(β), φ(d), and errors thereof. The retardation in the thickness direction was 180 nm, which was measured by the automatic birefringence meter KOBRA 21ADH manufactured by Oji Scientific Instruments.

Further, also the in-plane retardation was measured while increasing tensile load applied to the film in an ellipsometer M-150 manufactured by Jasco Corporation. The photoelastic coefficient was obtained from the results to be 15.5×10⁻¹² (1/Pa).

(Production of Polarizer)

A PVA having an average polymerization degree of 4,000 and a saponification degree of 99.8 mol % was dissolved in water to obtain a 4.0% aqueous solution. The solution was band-cast by using a tapered die and dried such that the resultant film had a width of 110 mm, a left end with a thickness of 120 μm, and a right end with a thickness of 135 μm before stretching.

The film was peeled off from the band, obliquely stretched in the 45-degree direction in the dry state, soaked in an aqueous solution containing 0.5 g/L of iodine and 50 g/L of potassium iodide at 30° C. for 1 minute, soaked in an aqueous solution containing 100 g/L of boric acid and 60 g/L of potassium iodide at 70° C. for 5 minutes, washed with water in an water bath at 20° C. for 10 seconds, and dried at 80° C. for 5 minutes, to obtain an iodine-based polarizer HF-01. The polarizer had a width of 660 mm, and the thickness thereof was 20 μm on both of the left and right.

(Production of Polarizing Plate)

The surface of the polymer substrate PK-1 of the optical compensation film KH-1 was attached to one side of the polarizer HF-01 using a polyvinyl alcohol adhesive. Further, a triacetylcellulose film FUJI TAC TD-80U was subjected to a surface saponification treatment in the same manner as WO 02/46809, Example 1, and attached to the other side of the polarizer using a polyvinyl alcohol adhesive.

The optical compensation film was disposed such that the retardation axis of the polymer substrate PK-1 was parallel to the transmission axis of the polarizer, and the triacetylcellulose film was disposed such that the retardation axis of the triacetylcellulose film was perpendicular to the transmission axis of the polarizer. Thus, a polarizing plate HB-1 according to the first embodiment of the invention was produced.

### Example 2

### Optical Compensation Film of the First Embodiment

In this Example, a cellulose acylate film, which had a small optical anisotropy (Re, Rth) to be substantially optical-isotropic and had a small wavelength dispersion of the optical anisotropy (Re, Rth), was used as a substrate to produce an optical compensation film according to the first embodiment.

(Production of Polymer Substrate)

The following composition was added to a mixing tank and stirred to dissolve the components, so that a cellulose acetate solution was prepared.

(Composition of Cellulose Acetate Solution)

| | | |
|---|---|---|
| Cellulose acetate having acetylation degree of | 100.0 | parts by mass |
| 2.86 | | |
| Methylene chloride (first solvent) | 402.0 | parts by mass |
| Methanol (second solvent) | 60.0 | parts by mass |

(Preparation of Matting Agent Solution)

20 parts by mass of silica particles having an average particle diameter of 16 nm (AEROSIL R972 available from Nippon Aerosil Co., Ltd.) and 80 parts by mass of methanol were well stirred for 30 minutes to obtain a silica particle dispersion liquid. The dispersion liquid was put in a disperser together with the following composition, and further stirred for 30 minutes or more to dissolve the components, to prepare a matting agent solution.

(Composition of Matting Agent Solution)

| | | |
|---|---|---|
| Dispersion liquid of silica particles having | 10.0 | parts by mass |
| average particle diameter of 16 nm | | |
| Methylene chloride (first solvent) | 76.3 | parts by mass |
| Methanol (second solvent) | 3.4 | parts by mass |
| Cellulose acetate solution D | 10.3 | parts by mass |

(Preparation of Additive Solution)

The following composition was put in a mixing tank, and stirred while heating to dissolve the components, so that a cellulose acetate solution was prepared. The example compound A-19 was used as the compound for reducing optical anisotropy, and the example compound UV-102 was used as the wavelength dispersion controlling agent.

(Composition of Additive Solution)

| | | |
|---|---|---|
| Compound for reducing optical anisotropy | 49.3 | parts by mass |
| Wavelength dispersion controlling agent | 7.6 | parts by mass |
| Methylene chloride (first solvent) | 58.4 | parts by mass |
| Methanol (second solvent) | 8.7 | parts by mass |
| Cellulose acetate solution | 12.8 | parts by mass |

(Production of Cellulose Acetate Film Sample)

94.6 parts by mass of the cellulose acetate solution, 1.3 parts by mass of the matting agent solution, 4.1 parts by mass of the additive solution were filtered respectively and then mixed, and cast by using a band casting apparatus. In the composition, the mass ratios of the compound for reducing optical anisotropy and the wavelength dispersion controlling agent to the cellulose acetate were 12% and 1.8%, respectively. The film was peeled from the band at the residual solvent content of 30%, and dried at 140° C. for 40 minutes, to produce a substrate PK-2 of the cellulose acetate film. The substrate PK-2 had a width of 1,500 mm and a thickness of 40 μm. The cellulose acetate film had a residual solvent content of 0.2%. The value of |Re(400)−Re(700)| was 1.0, and the value of |Rth(400)−Rth(700)| was 2.8. Further, the retardation (Rth) at the wavelength of 590 nm was 18 nm.

ΔRth (=Rth10% RH−Rth80% RH) of the obtained sample, which was difference between retardations in the thickness direction under relative humidity of 10% and 80%, was measured. As a result, ΔRth was within the range of 0 to 30 nm, and it was confirmed that the humidity dependency was reduced.

(Production of Optical Compensation Film Having Optically Anisotropic Layer)

The polymer substrate PK-2 was soaked in a 2.0 N potassium hydroxide solution at 25° C. for 2 minutes, neutralized with sulfuric acid, washed with pure water, and dried. The material PK-2 had a contact angle of 35 degrees against water and a surface energy of 63 mN/m, which were obtained by a contact angle method.

(Formation of Alignment Layer)

A coating liquid having the following formulation was applied to the obtained PK-2 at the application rate of 28 ml/m² by a #16 wire-bar coater. The applied liquid was dried by hot air having a temperature of 60° C. for 60 seconds, and further dried by hot air having a temperature of 90° C. for 150 seconds, to form a layer.

(Formulation of Alignment Layer Coating Liquid)

| | | |
|---|---|---|
| Following modified polyvinyl alcohol | 13.5 | parts by mass |
| Polyvinyl alcohol (PVA117 available | 1.5 | parts by mass |
| from Kuraray Co., Ltd.) | | |
| Water | 361 | parts by mass |
| Methanol | 119 | parts by mass |
| Glutaraldehyde (crosslinking agent) | 0.5 | parts by mass |

Modified polyvinyl alcohol

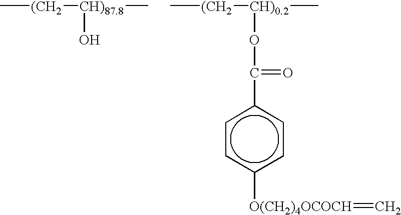

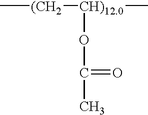

The formed layer was rubbed in the direction parallel to the longitudinal direction of PK-2 to obtain an alignment layer.

(Formation of Optically Anisotropic Layer)

41.01 kg of the discotic compound (A) used in Example 1, 4.06 kg of an ethylene oxide-modified trimethylolpropane triacrylate V#360 available from Osaka Organic Chemical Industry Ltd., 0.90 kg of a cellulose acetate butyrate CAB551-0.2 available from Eastman Chemicals Co., 0.23 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., 0.31 kg of a fluorine-containing surfactant, and 0.29 kg of a chiral agent for twisting the discotic liquid crystal were dissolved in 102 kg of methyl ethyl ketone to obtain a coating liquid. The coating liquid was applied to the alignment layer by a #8 wire bar, and heated in a constant-temperature zone at 130° C. for 2 minutes to align the discotic compound. Then, the resultant laminate was irradiated with UV at 60° C. for 1 minute by a 120-W/cm high-pressure mercury vapor lamp to polymerize the discotic compound (A), and was cooled to the room temperature. Thus an optically anisotropic layer was formed by polymerization to produce an optical compensation film KH-2.

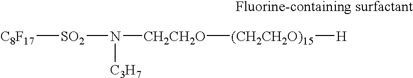

The formed optically anisotropic layer had a thickness of 3.2 μm. As a result of observing the optically anisotropic layer prepared separately in crossed nicols alignment by a polarization microscope, the discotic molecules were twisted counterclockwise observed from the air interface from the transparent support to the air, and the twist angle φ obtained from the extinction was 18.0°. The retardation Re of only the optically anisotropic layer was 28 nm at the wavelength of 590 nm. Further, the mean value β of the averages a and b of the angles between the interfaces and the major axes (the discotic planes) of the discotic molecules was 37°.

The optical compensation film KH-2 had a retardation Rth in the thickness direction of 190 nm, which was measured at the wavelength of 590 nm by an automatic birefringence meter KOBRA 21ADH manufactured by Oji Scientific Instruments.

The polarizing plate was turned into the crossed nicols state, and unevenness of the obtained optical compensation film was evaluated. As a result, unevenness was not detected by observation from the front and from the direction at 60° against the normal line.

Table 1 shows main properties of the transparent support and the optically anisotropic layer of the optical compensation film KH-2, and d(Rth), Rth(β), and φ(d) defined in the conditions of (1) to (3), and errors thereof.

(Production of Polarizing Plate)

The optical compensation film KH-2 was attached to one side of the polarizer HF-1 using a polyvinyl alcohol adhesive. Further, a triacetylcellulose film FUJI TAC TD-80U was subjected to a saponification treatment in the same manner as Example 1, and attached to the other side of the polarizer using a polyvinyl alcohol adhesive.

The optical compensation film was disposed such that the retardation axis of the polymer substrate PK-2 was parallel to the transmission axis of the polarizer, and the triacetylcellulose film was disposed such that the retardation axis of the triacetylcellulose film was perpendicular to the transmission axis of the polarizer. Thus, a polarizing plate HB-2 was produced.

(Evaluation in TN Liquid Crystal Cell)

From a liquid crystal display using a TN liquid crystal cell (AQUOS LC20C1S manufactured by Sharp Kabushiki Kaisha), a pair of polarizing plates were peeled off. The retardation of the liquid crystal layer and the twist direction of the liquid crystal thereof were measured by a general-purpose ellipsometer “H33” manufactured by Thing Tech Co., Ltd. It was found that the retardation was about 0.4 μm, and the liquid crystal cell was twisted at approximately 90° clockwise from observer's viewpoint form the light source to the display surface. The drive circuit was modified to reduce the driving voltage of the liquid crystal display by 20%. Instead of the peeled polarizing plates, the polarizing plates HB-1 and HB-2 produced in Examples 1 and 2 were attached to the observer side and the backlight side using an adhesive respectively such that the optical compensation films KH-1 and KH-2 faced the liquid crystal cell. The absorption axis of the polarizing plate on the observer side was parallel to the rubbing axis of the liquid crystal layer on the observer side, and the absorption axes of the upper and lower polarizing plates were perpendicular to each other.

The viewing angles of thus produced liquid crystal displays were evaluated using 8 classifications of from black display (L0) to white display (L7) by a measuring apparatus EZ-Contrast 160D manufactured by ELDIM. Table 2 shows the viewing angles of the liquid crystal displays of Examples 1 and 2 in the directions of up, down, left, and right at the contrast ratio of 10 or more. Table 3 shows the viewing angles of the liquid crystal display of Example 1 in the directions of up, down, left, and right at the contrast ratio of 30 or more. Further, the grayscale inversion angles of the liquid crystal displays of Examples 1 and 2, at which L1 and L2 intersected with each other, were measured. The results are shown in Table 2.

TABLE 1

| | Obtained and calculated values with regard | | | | | |
|---|---|---|---|---|---|---|
| | to properties of optically anisotropic layer | | | | | |
| | | | | | | Calculated |
| | | Calculated | Obtained | Calculated | Obtained | value of |
| | Obtained | value of β | value of | value of d | average | φ(d) |
| | value of β | (Error) | thickness d | (Error) | twist angle φ | (Error) |
| Example 1 | 38° | 38.6° | 2.6 μm | 2.53 μm | 15.6° | 14.1° |
| | | (−2%) | | (+3%) | | (+11%) |
| Example 2 | 37° | 36.8° | 3.2 μm | 2.79 μm | 18.0° | 19.7° |
| | | (0%) | | (+15%) | | (−9%) |

TABLE 2
Viewing angle (at contrast ratio of 10 or more)

| | Polarizing plate | Up | Down | Left | Right | Total | |
|---|---|---|---|---|---|---|---|
| Example 1 | HB-1 | 80° | 80° | 80° | 80° | 320° | ◯ |
| Example 2 | HB-2 | 50° | 80° | 80° | 80° | 290° | ◯ |

The liquid crystal display of Example 1 uses the optical compensation film that satisfies the conditions of (1) to (3) described in above embodiments. The liquid crystal display of Example 2 uses the optical compensation film that satisfies the conditions of (1) and (3) and does not satisfy the condition of (2). It is understandable that the liquid crystal display of Example 1 was particularly excellent in the viewing angles, though both the displays had wide viewing angles.

TABLE 3
Viewing angle at contrast ratio of 30 or more

| | | | | |
|---|---|---|---|---|
| Polarizing plate | Up | Down | Left | Right |

| | | | | | |
|---|---|---|---|---|---|
| Example 1 | HB-1 | 46° | 54° | 65° | 65° |

The viewing angles at the contrast ratio of 30 or more were evaluated in the same manner as Examples of Patent Document 2. The same evaluation conditions were used to show the performance advantages of the Examples of the invention as compared with Examples of Patent Document 2.

TABLE 4
Grayscale inversion angle (angle at which tone levels L1 and L2 intersect)

| | Underside |
|---|---|
| Example 1 | 43° |
| Example 2 | 33° |

The liquid crystal display of Example 1 satisfying all the conditions of (1) to (3) had the grayscale inversion angle larger than that of the display of Example 2, and it is understandable that the grayscale inversion was improved in Example 1. On the other hand, it is understandable that, in Example 2, the value d calculated from Rth was excessively large, thereby resulting in the grayscale inversion angle of less than 37°.

(Evaluation of Unevenness of Liquid Crystal Display Panel)

The display panel of each liquid crystal display of Examples 1 and 2 was entirely controlled at the grey level to evaluate the unevenness. Large unevenness was not observed in both the liquid crystal displays of Examples 1 and 2, and the display of Example 1 had smaller viewing angle unevenness and color unevenness.

### Example 3

### Optical Compensation Film of First Embodiment

(Preparation of Polymer Substrate, Undercoat Layer, and Alignment Layer)

An alignment layer was formed by using the transparent substrate PK-1 in the same manner as Example 1. The rubbing axis of the alignment layer was parallel to the retardation axis.

(Formation of Optically Anisotropic Layer)

41.01 kg of the discotic compound (A) used in Example 1, 4.06 kg of an ethylene oxide-modified trimethylolpropane triacrylate V#360 available from Osaka Organic Chemical Industry Ltd., 0.35 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., and 0.31 kg of above fluorine-containing surfactant were dissolved in 102 kg of methyl ethyl ketone to obtain a coating liquid. The coating liquid was continuously applied to the alignment layer by a #4.0 wire bar, and heated at 130° C. for 2 minutes to align the discotic compound. Then, the resultant laminate was irradiated with UV at 100° C. for 1 minute by a 120 W/cm high-pressure mercury vapor lamp to polymerize the discotic compound, and was cooled to the room temperature. Thus an optical compensation film KH-3 comprising non-twisted discotic liquid crystal molecules was produced. As a result of measuring the thickness of the optically anisotropic layer prepared separately, the thickness was 2.6 μm. It was confirmed that the extinction axis corresponded to the rubbing axis in the crossed nicols state of the optically anisotropic layer, and thus the DLC layer had no twist structure. The retardation of the optically anisotropic layer was 41 nm at a wavelength of 590 nm. Further, the mean value β of the averages a and b of the angles between the interfaces and the major axes (the discotic planes) of the discotic molecules was 38°.

The polarizing plate was turned into the crossed nicols state, and unevenness of the obtained optical compensation film was evaluated. As a result, unevenness was not detected by observation from the front and from the direction at 60° against the normal line.

Table 5 shows main properties of the transparent support and the optically anisotropic layer of the optical compensation film KH-3, and d(Rth), Rth(β), and φ(d) defined in the conditions of (1) to (3), and errors thereof. The retardation of the optical compensation film KH-3 in the thickness direction was 180 nm, which was measured by the automatic birefringence meter KOBRA 21ADH manufactured by Oji Scientific Instruments.

Further, also the in-plane retardation was measured while increasing tensile load applied to the film in an ellipsometer. The photoelastic coefficient was obtained from the results to be 15.3×10⁻¹² (1/Pa)

(Production of Polarizer)

A polarizer HF-01 was produced under the same conditions by the same method as Example 1. The polarizer had a width of 660 mm, and left and right thicknesses of 20 μm.

(Production of Polarizing Plate)

The surface of the polymer substrate PK-1 of the optical compensation film KH-3 was attached to one side of the polarizer HF-01 using a polyvinyl alcohol adhesive. Further, a triacetylcellulose film FUJI TAC TD-80U was subjected to a surface saponification treatment in the same manner as WO 02/46809, Example 1, and attached to the other side of the polarizer using a polyvinyl alcohol adhesive.

The optical compensation film was disposed such that the retardation axis of the polymer substrate PK-1 was parallel to the transmission axis of the polarizer, and the triacetylcellulose film was disposed such that the retardation axis of the triacetylcellulose film was perpendicular to the transmission axis of the polarizer. Thus, a polarizing plate HB-3 was produced.

### Comparative Example 1

(Production of Polymer Substrate, Undercoat Layer, and Alignment Layer)

An alignment layer was formed on the transparent substrate PK-1 in the same manner as Example 1. The rubbing axis of the alignment layer was parallel to the retardation axis.

(Formation of Optically Anisotropic Layer)

41.01 kg of the discotic compound (A) used in Example 1, 4.06 kg of an ethylene oxide-modified trimethylolpropane triacrylate V#360 available from Osaka Organic Chemical Industry Ltd., 0.35 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., 0.92 kg of above fluorine-containing surfactant, and 0.29 kg of a chiral agent equal to those used in Examples 1 and 2 were dissolved in 102 kg of methyl ethyl ketone to obtain a coating liquid. The coating liquid was continuously applied to the alignment layer by a #4.0 wire bar, and heated at 130° C. for 2 minutes to align the discotic compound. Then, the resultant laminate was irradiated with UV at 100° C. for 1 minute by a 120 W/cm high-pressure mercury vapor lamp to polymerize the discotic compound, and was cooled to the room temperature. Thus an optical compensation film KH-4 having an optically anisotropic layer was produced.

The optically anisotropic layer had a thickness of 2.6 μm. The retardation of only the optically anisotropic layer was 42 nm at the wavelength of 590 nm. Further, the mean value β of the averages a and b of the angles between the interfaces and the major axes (the discotic planes) of the discotic molecules was 42°. As a result of observing the optically anisotropic layer prepared separately in crossed nicols alignment by a polarization microscope, the discotic molecules were twisted counterclockwise observed from the air interface from the transparent support to the air, and the twist angle obtained from the extinction was 15°. The polarizing plate was turned into the crossed nicols state, and unevenness of the obtained optical compensation film was evaluated. As a result, unevenness was not detected by observation from the front and from the direction at 60° against the normal line.

Table 5 shows main properties of the transparent support and the optically anisotropic layer of the optical compensation film KH-4, and d(Rth), Rth(β), and φ(d) defined in the conditions of (1) to (3), and errors thereof. The retardation Rth in the thickness direction was 200 nm, which was measured by the automatic birefringence meter KOBRA 21ADH manufactured by Oji Scientific Instruments.

(Production of Polarizer)

A polarizer HF-01 was produced under the same conditions by the same method as Example 1. The polarizer had a width of 660 mm, and left and right thicknesses of 20 μm.

(Production of Polarizing Plate)

The surface of the polymer substrate PK-1 of the optical compensation film KH-4 was attached to one side of the polarizer HF-01 using a polyvinyl alcohol adhesive. Further, a triacetylcellulose film FUJI TAC TD-80U was subjected to a surface saponification treatment in the same manner as WO 02/46809, Example 1, and attached to the other side of the polarizer using a polyvinyl alcohol adhesive.

The optical compensation film was disposed such that the retardation axis of the polymer substrate PK-1 was parallel to the transmission axis of the polarizer, and the triacetylcellulose film was disposed such that the retardation axis of the triacetylcellulose film was perpendicular to the transmission axis of the polarizer. Thus, a polarizing plate HB-4 was produced.

(Evaluation in TN Liquid Crystal Cell)

The polarizing plates HB-3 and HB-4 were attached using an adhesive respectively to the observer side and the backlight side of the liquid crystal cell of the liquid crystal display (AQUOS LC20C1S manufactured by Sharp Kabushiki Kaisha) such that the optical compensation films KH-3 and KH-4 faced the cell. The absorption axis of the polarizing plate on the observer side was parallel to the rubbing axis of the liquid crystal layer on the observer side, and perpendicular to that of the polarizing plate on the backlight side. The drive circuit was modified to reduce the driving voltage of the liquid crystal display by 20% in the same manner as above.

The viewing angles of thus produced liquid crystal displays were evaluated using 8 classifications of from black display (L0) to white display (L7) by a measuring apparatus EZ-Contrast 160D manufactured by ELDIM. Table 6 shows the viewing angles of the liquid crystal displays of Comparative Examples 3 and 4 in the directions of up, down, left, and right at the contrast ratio of 10 or more. Further, the grayscale inversion angles of the liquid crystal displays of Comparative Examples 3 and 4, at which the tone levels L1 and L2 intersected with each other, were measured. The results are shown in Table 7.

TABLE 5

| | Obtained and calculated values with regard to properties | | | | | |
|---|---|---|---|---|---|---|
| | of optically anisotropic layer | | | | | |
| | | Calculated | | Calculated | Obtained | Calculated |
| | | β(Rth) | Obtained | d(Rth) | average twist | φ(d) |
| | Obtained β | (Error) | thickness d | (Error) | angle φ | (Error) |
| Example 3 | 38° | 38.6° | 2.6 μm | 2.53 μm | 0° | 14.1° |
| | | (−2%) | | (+3%) | | (−100%) |
| Comparative | 42° | 38.6° | 2.6 μm | 2.53 μm | 15.0° | 14.1° |
| Example 1 | | (+9%) | | (+3%) | | (+7%) |

TABLE 6
Viewing angle (at contrast ratio of 10 or more)

| | Polarizing plate | Up | Down | Left | Right | Total | |
|---|---|---|---|---|---|---|---|
| Example 3 | HB-3 | 80° | 70° | 80° | 80° | 310° | ◯ |
| Comparative | HB-4 | 50° | 65° | 80° | 80° | 275° | X |
| Example 1 | | | | | | | |

The liquid crystal display of Example 3 uses the optical compensation film that satisfies the conditions of (1) and (2) and does not satisfy the condition of (3), the liquid crystal molecules in the optically anisotropic layer being not in the twisted alignment state. The liquid crystal display of Comparative Example 1 has excessively large value of β. The display of Example 3 had 280° or more of the desired total viewing angle in the directions of up, down, left, and right, while the display of Comparative Example 1 failed to have the desired angle.

TABLE 7
Grayscale inversion angle (angle at which tone levels L1 and L2 intersect)

| | Underside |
|---|---|
| Example 3 | 34° |
| Comparative Example 1 | 39° |

The display of Example 3 had sufficient total viewing angle though it had slightly insufficient grayscale inversion angle of less than 37° on the underside. The display of Comparative Example 4 had insufficient total viewing angle though it showed sufficient effect of improving the grayscale inversion angle on the underside.

It was found that the display of Example 1, which used the optical compensation film satisfying all the conditions of (1) to (3), was particularly excellent in both of the total viewing angle in the directions of up, down, left, and right, and the grayscale inversion angle on the underside.

The polarizing plates HB-1 and HB-3 of Examples 1 and 3 had photoelastic coefficients of about 15×10⁻¹² (1/Pa). The backlight of each liquid crystal display employing the polarizing plates was kept on continuously for 5 hours at 25° C. at the relative humidity of 60%, and the entire black display was visually observed in a darkroom to evaluate light leakage in the periphery of the display surface. As a result, in the case of Example 1 (HB-1), light leakage was not observed, and the maximum luminance measured by a luminance meter was 0.6 cd/m². On the other hand, in the case of Example 3 (HB-3), light leakage was observed, and the luminance in the black state was 1.5 cd/m². Thus, light leakage was not observed in the case of the optically anisotropic layer having the twist structure (Example 1), while it was observed in the case of the optically anisotropic layer without twist structure (Example 3).

### Example 5

### Optical Compensation Film of the Second Embodiment

(Production of Polymer Substrate)

The following composition was put in a mixing tank, and stirred while heating to dissolve the components, so that a cellulose acetate solution was prepared.

(Composition of Cellulose Acetate Solution)

| | | |
|---|---|---|
| Cellulose acetate having acetylation degree of | 80 | parts by mass |
| 60.9% (linter) | | |
| Cellulose acetate having acetylation degree of | 20 | parts by mass |
| 60.8% (linter) | | |
| Triphenyl phosphate (plasticizer) | 7.8 | parts by mass |
| Biphenyldiphenyl phosphate (plasticizer) | 3.9 | parts by mass |
| Methylene chloride (first solvent) | 300 | parts by mass |
| Methanol (second solvent) | 54 | parts by mass |
| 1-Butanol (third solvent) | 11 | parts by mass |

4 parts by mass of cellulose acetate having an acetylation degree of 60.9% (a linter), 16 parts by mass of the following retardation increasing agent, 0.5 parts by mass of fine silica particles having a particle diameter of 20 nm and a Mohs' hardness of about 7, 87 parts by mass of methylene chloride, and 13 parts by mass of methanol were put in another mixing tank, and stirred under heating to prepare a retardation increasing agent solution.

28 parts by mass of the retardation increasing agent solution was mixed with 464 parts by mass of the cellulose acetate solution, and well stirred to prepare a dope. The amount of the retardation increasing agent was 5.0 parts by mass per 100 parts by mass of cellulose acetate.

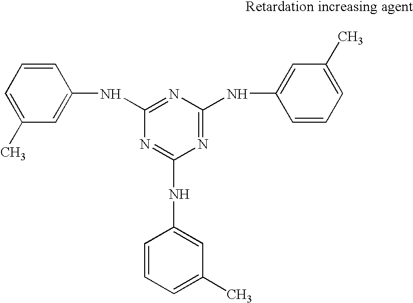

Thus-obtained polymer substrate PK-3 had a width of 1,340 mm and a thickness of 92 μm. The retardation Re was 43 nm and the retardation Rth was 125 nm, they being measured by an automatic birefringence meter KOBRA 21ADH manufactured by Oji Scientific Instruments.

Further, the hygroscopic expansion coefficient of the produced polymer substrate PK-3 was 12.0×10⁻⁵/% RH.

(Production of Undercoat Layer)

A coating liquid having the following formulation was applied at 28 ml/m² to the cellulose acetate film support, and dried to form a 0.1 μm gelatin layer (an undercoat layer).

Formulation of undercoat layer coating liquid

| | | |
|---|---|---|
| Gelatin | 0.542 | parts by mass |
| Formaldehyde | 0.136 | parts by mass |
| Salicylic acid | 0.160 | parts by mass |
| Acetone | 39.1 | parts by mass |
| Methanol | 15.8 | parts by mass |
| Methylene chloride | 40.6 | parts by mass |
| Water | 1.2 | parts by mass |

An alignment layer coating liquid having the following formulation was applied to PK-3 at 28 ml/m² by a #16 wire-bar coater. The applied liquid was dried by hot air having a temperature of 60° C. for 60 seconds, and further dried by hot air having a temperature of 90° C. for 150 seconds, to form a layer.

(Formulation of Alignment Layer Coating Liquid)

| | | |
|---|---|---|
| Following modified polyvinyl alcohol | 10 | parts by mass |
| Water | 371 | parts by mass |
| Methanol | 119 | parts by mass |
| Glutaraldehyde (crosslinking agent) | 0.5 | parts by mass |

Modified polyvinyl alcohol

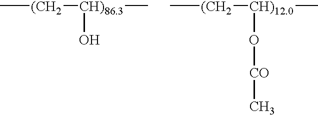

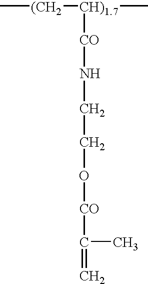

The formed layer was rubbed in the direction of the retardation axis of the polymer substrate PK-3 to form an alignment layer.

(Formation of Optically Anisotropic Layer)

41.01 kg of the following discotic compound (A), 4.06 kg of an ethylene oxide-modified trimethylolpropane triacrylate V#360 available from Osaka Organic Chemical Industry Ltd., 0.35 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., and 0.52 kg of the following fluorine-containing surfactant were dissolved in 102 kg of methyl ethyl ketone to obtain a coating liquid. The coating liquid was continuously applied to the alignment layer by a #3.0 wire bar, and heated at 130° C. for 2 minutes to align the discotic compound.

Then, the resultant laminate was irradiated with UV at 100° C. for 1 minute by a 120-W/cm high-pressure mercury vapor lamp to polymerize the discotic compound, and was cooled to the room temperature. Thus an optical compensation film KH-5 having an optically anisotropic layer was produced.

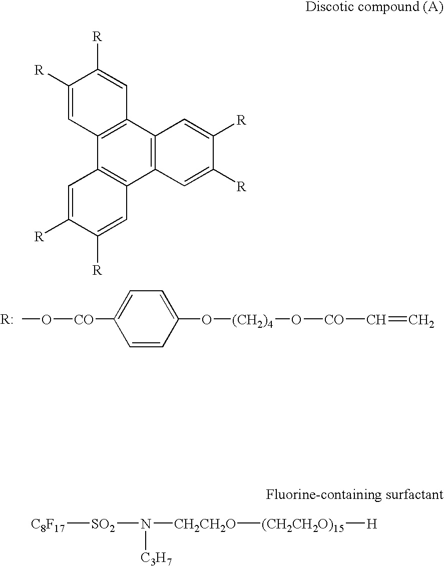

The formed optically anisotropic layer had a thickness of 2.0 μm.

The film comprising the optically anisotropic layer was obliquely cut and subjected to a measurement using a polarization raman spectroscopy, whereby the mean tilt angles of the molecules were obtained on the polymer substrate interface and the air interface respectively. The average a of the angles of the major axes (the discotic planes) of the discotic compound against the support was 42°, and the average b of the angles of the major axes (the discotic planes) of the discotic compound against the air interface was 44°.

The polarizing plate was turned into the crossed nicols state, and unevenness of the obtained optical compensatory sheet was evaluated. As a result, unevenness was not detected by observation from the front and from the direction at 60° against the normal line.

Table 8 shows main properties of the transparent support and the optically anisotropic layer of the optical compensation film KH-5. The lower and upper limit values of Rth according to the condition of (5) are also shown in Table 8.

(Production of Polarizer)

A PVA having an average polymerization degree of 4,000 and a saponification degree of 99.8 mol % was dissolved in water to obtain a 4.0% aqueous solution. The solution was band-cast by using a tapered die and dried such that the resultant film had a width of 110 mm, a left end thickness of 120 μm, and a right end thickness of 135 μm before stretching.

The film was peeled off from the band, obliquely stretched in the 45-degree direction in the dry state, soaked in an aqueous solution containing 0.5 g/L of iodine and 50 g/L of potassium iodide at 30° C. for 1 minute, soaked in an aqueous solution containing 100 g/L of boric acid and 60 g/L of potassium iodide at 70° C. for 5 minutes, washed with water in an water bath at 20° C. for 10 seconds, and dried at 80° C. for 5 minutes, to obtain an iodine-based polarizer HF-01. The polarizer had a width of 660 mm, and the thickness thereof was 20 μm on both of the left and right.

(Production of Polarizing Plate)

The surface of the polymer substrate PK-3 of the optical compensatory sheet KH-5 was attached to one side of the polarizer HF-01 using a polyvinyl alcohol adhesive. Further, a triacetylcellulose film FUJI TAC TD-80U was subjected to a surface saponification treatment in the same manner as WO 02/46809, Example 1, and attached to the other side of the polarizer using a polyvinyl alcohol adhesive.

The optical compensation film was disposed such that the retardation axis of the polymer substrate PK-3 was parallel to the transmission axis of the polarizer, and the triacetylcellulose film was disposed such that the retardation axis of the triacetylcellulose film was perpendicular to the transmission axis of the polarizer. Thus, a polarizing plate HB-5 was produced.

### Example 6

### Optical Compensation Film of Second Embodiment

In Example 6, a cellulose acylate film, which had a small optical anisotropy (Re, Rth) and a small wavelength dispersion thereof was used as a substrate.

(Production of Polymer Substrate)

(Preparation of Cellulose Acetate Solution)

The following composition was put in a mixing tank, and stirred to dissolve the components, so that a cellulose acetate solution was prepared.

(Composition of Cellulose Acetate Solution)

| | | |
|---|---|---|
| Cellulose acetate having acetylation degree of | 100.0 | parts by mass |
| 2.86 | | |
| Methylene chloride (first solvent) | 402.0 | parts by mass |
| Methanol (second solvent) | 60.0 | parts by mass |

(Preparation of Matting Agent Solution)

20 parts by mass of silica particles having an average particle diameter of 16 nm (AEROSIL R972 available from Nippon Aerosil Co., Ltd.) and 80 parts by mass of methanol were well stirred for 30 minutes to obtain a silica particle dispersion liquid. The dispersion liquid was put in a disperser together with the following composition, and further stirred for 30 minutes or more to dissolve the components, to prepare a matting agent solution.

(Composition of Matting Agent Solution)

| | | |
|---|---|---|
| Dispersion liquid of silica particles having | 10.0 | parts by mass |
| average particle diameter of 16 nm | | |
| Methylene chloride (first solvent) | 76.3 | parts by mass |
| Methanol (second solvent) | 3.4 | parts by mass |
| Cellulose acetate solution D | 10.3 | parts by mass |

(Preparation of Additive Solution)

The following composition was put in a mixing tank, and stirred while heating to dissolve the components, so that a cellulose acetate solution was prepared. The example compound A-19 was used as the compound for reducing optical anisotropy, and the example compound UV-102 was used as the wavelength dispersion controlling agent.

(Composition of Additive Solution)

| | |
|---|---|
| Compound for reducing optical anisotropy | 49.3 parts by mass |
| Wavelength dispersion controlling agent | 7.6 parts by mass |
| Methylene chloride (first solvent) | 58.4 parts by mass |
| Methanol (second solvent) | 8.7 parts by mass |
| Cellulose acetate solution | 12.8 parts by mass |

(Production of Cellulose Acetate Film Sample)

94.6 parts by mass of the cellulose acetate solution, 1.3 parts by mass of the matting agent solution, 4.1 parts by mass of the additive solution were filtered respectively and then mixed, and cast by using a band casting apparatus. In the composition, the mass ratios of the compound for reducing optical anisotropy and the wavelength dispersion controlling agent to the cellulose acetate were 12% and 1.8%, respectively. The film was peeled from the band at the residual solvent content of 30%, and dried at 140° C. for 40 minutes, to produce a substrate PK-4 of the cellulose acetate film. The substrate PK-4 had a width of 1,500 mm and a thickness of 40 μm. The cellulose acetate film had a residual solvent content of 0.2%. The retardations Re and Rth were respectively 28 nm and 18 nm, which were obtained in the same manner as Example 5. The value of |Re(400)−Re(700)| was 1.0, and the value of |Rth(400)−Rth(700)| was 2.8.

ΔRth (=Rth10% RH−Rth80% RH) of the polymer film, which was difference between retardations in the thickness direction under relative humidity of 10% and 80%, was measured. As a result, ΔRth was within the range of 0 to 30 nm, and it was confirmed that the humidity dependency was reduced.

(Production of Optical Compensatory Sheet Having Optically Anisotropic Layer)

The polymer substrate PK-4 was soaked in a 2.0 N potassium hydroxide solution at 25° C. for 2 minutes, neutralized with sulfuric acid, washed with pure water, and dried. The substrate PK-4 had a contact angle of 35 degrees against water and a surface energy of 63 mN/m, obtained by a contact angle method.

(Formation of Alignment Layer)

A coating liquid having the following composition was applied to the obtained PK-4 at the application rate of 28 ml/m² by a #16 wire-bar coater. The applied liquid was dried by hot air having a temperature of 60° C. for 60 seconds, and further dried by hot air having a temperature of 90° C. for 150 seconds, to form a layer.

(Composition of Alignment Layer Coating Liquid)

| | | |
|---|---|---|
| Following modified polyvinyl alcohol | 13.5 | parts by mass |
| Polyvinyl alcohol (PVA117 available | 1.5 | parts by mass |
| from Kuraray Co., Ltd.) | | |
| Water | 361 | parts by mass |
| Methanol | 119 | parts by mass |
| Glutaraldehyde (crosslinking agent) | 0.5 | parts by mass |

Modified polyvinyl alcohol

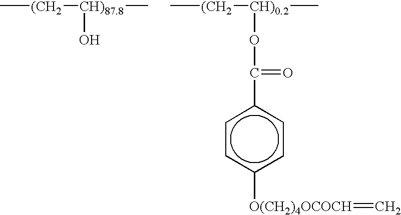

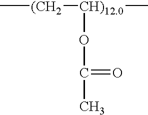

The layer was rubbed in the direction parallel to the longitudinal direction of PK-4 to obtain an alignment layer.

(Formation of Optically Anisotropic Layer)

41.01 kg of the discotic compound (A) equal to that used in Example 5, 4.06 kg of an ethylene oxide-modified trimethylolpropane triacrylate V#360 available from Osaka Organic Chemical Industry Ltd., 0.90 kg of a cellulose acetate butyrate CAB551-0.2 available from Eastman Chemicals Co., 0.23 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., and 0.85 kg of a fluorine-containing surfactant equal to that used in Example 1 were dissolved in 102 kg of methyl ethyl ketone to obtain a coating liquid. The coating liquid was applied to the alignment layer by a #3 wire bar, and heated in a constant-temperature zone at 130° C. for 2 minutes to align the discotic compound. Then, the resultant laminate was irradiated with UV at 60° C. for 1 minute by a 120 W/cm high-pressure mercury vapor lamp to polymerize the discotic compound (A), and was cooled to the room temperature. Thus an optical compensatory sheet KH-6 having an optically anisotropic layer was produced.

The formed optically anisotropic layer had a thickness of 1.95 μm.

The film comprising the optically anisotropic layer was obliquely cut and subjected to a measurement using a polarization raman spectroscopy, whereby the tilt angles of the molecules were obtained on the polymer substrate interface and the air interface respectively. The average a of the angles of the major axes (the discotic planes) of the discotic compound against the support was 46°, and the average b of the angles of the major axes (the discotic planes) of the discotic compound against the air interface was 41°. It was confirmed that inclination of the discotic planes of the discotic compound molecules varied from the transparent support interface to the air interface in the hybrid alignment.

The polarizing plate was turned into the crossed nicols state, and unevenness of the obtained optical compensatory sheet was evaluated. As a result, unevenness was not detected by observation from the front and from the direction at 60° against the normal line. Table 8 shows main properties of the transparent support and the optically anisotropic layer of the optical compensation film KH-6. The lower and upper limit values of Rth are also shown in Table 8.

(Production of Polarizing Plate)

The optical compensatory sheet KH-6 was attached to one side of the polarizer HF-01 using a polyvinyl alcohol adhesive. Further, a triacetylcellulose film FUJI TAC TD-80U was subjected to a saponification treatment in the same manner as Example 5, and attached to the other side of the polarizer using a polyvinyl alcohol adhesive.

The optical compensation film was disposed such that the retardation axis of the polymer substrate PK-4 was parallel to the transmission axis of the polarizer, and the triacetylcellulose film was disposed such that the retardation axis of the triacetylcellulose film was perpendicular to the transmission axis of the polarizer. Thus, a polarizing plate HB-6 was produced.

(Evaluation in TN Liquid Crystal Cell)

From a liquid crystal display using a TN liquid crystal cell (AQUOS LC20C1S manufactured by Sharp Kabushiki Kaisha), a pair of polarizing plates were peeled off. Instead of the peeled polarizing plates, the polarizing plates HB-5 and HB-6 produced in Examples 5 and 6 were attached to the observer side and the backlight side using an adhesive respectively such that the optical compensation films KH-5 and KH-6 faced the liquid crystal cell. The absorption axis of the polarizing plate on the observer side was parallel to the rubbing axis of the liquid crystal layer on the observer side, and perpendicular to the absorption axis of the polarizing plate on the backlight side.

The viewing angles and the grayscale inversion angles of thus produced liquid crystal displays were evaluated using 8 classifications of from black display (L0) to white display (L7) by a measuring apparatus EZ-Contrast 160D manufactured by ELDIM. The results are shown in Tables 9 and 10.

TABLE 8
Properties of optically anisotropic layer and transparent support

| | | | | Optically anisotropic layer | | | |
|---|---|---|---|---|---|---|---|
| | | | | | | Angle at | Angle at |
| | Transparent support | | | | Mean tilt | support | air interface |
| | Rth | | | Thickness | angle | side | side |
| | (nm) | 255 × e^{-0.66d} | 330 × e^{-0.46d} | d (μm) | β (deg.) | a (deg.) | b (deg.) |
| Example 5 | 125 | 68 | 132 | 2.0 | 43 | 42 | 44 |
| Example 6 | 18 | 70 | 135 | 1.95 | 44 | 46 | 41 |

TABLE 9
Viewing angle (at contrast ratio of 10 or more)

| | Polarizing plate | Up | Down | Left | Right | Total |
|---|---|---|---|---|---|---|
| Example 5 | HB-5 | 80° | 65° | 80° | 80° | 305° |
| Example 6 | HB-6 | 53° | 45° | 56° | 56° | 210° |

TABLE 10
Grayscale inversion angle
(angle at which tone levels L1 and L2 intersect)

| | Underside |
|---|---|
| Example 5 | 40° |
| Example 6 | 38° |

(Evaluation of Unevenness on Liquid Crystal Display Panel)

The liquid crystal display of Example 5 employing the optical compensation film, which satisfies the relations of the retardation Rth in the thickness direction of the transparent support, the thickness d of the optically anisotropic layer, the mean value β, and the tilt angle of the discotic compound layer, and the conditions of (5) and (6), had wider viewing angles and improved grayscale inversion. On the other hand, the liquid crystal display of Example 6 employing the optical compensation film, which satisfied the condition of (5) and did not satisfy the condition of (6) between the thickness d of the optically anisotropic layer and Rth of the transparent substrate, had viewing angle properties inferior to those of Example 5, though it had improved grayscale inversion.

Further, the display panel of each liquid crystal display of Examples 5 and 6 was entirely controlled at the grey level to evaluate unevenness. Unevenness was not detected by observation from any direction in Examples 5 and 6.

### Example 7

### Retardation Film of the Second Embodiment

(Preparation of Polymer Substrate, Undercoat Layer, and Alignment Layer)

An alignment layer was formed on the transparent substrate PK-3 produced in Comparative Example 1 in the same manner as Example 5. The rubbing axis of the alignment layer was parallel to the retardation axis.

(Formation of Optically Anisotropic Layer)

41.01 kg of a discotic compound (A) equal to that used in Example 5, 4.06 kg of an ethylene oxide-modified trimethylolpropane triacrylate V#360 available from Osaka Organic Chemical Industry Ltd., 0.35 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., and 0.52 kg of a fluorine-containing surfactant equal to that used in Example 5 were dissolved in 102 kg of methyl ethyl ketone to obtain a coating liquid. The coating liquid was continuously applied to the alignment layer by a #1.0 wire bar, and heated at 130° C. for 2 minutes to align the discotic compound. Then, the resultant laminate was irradiated with UV at 100° C. for 1 minute by a 120 W/cm high-pressure mercury vapor lamp to polymerize the discotic compound, and was cooled to the room temperature. Thus an optical compensatory sheet KH-7 comprising non-twisted discotic liquid crystal molecules was produced.

The formed optically anisotropic layer comprising the discotic compound had a thickness of 1.1 μm. The film comprising the discotic compound was obliquely cut, and measured with respect to each mean tilt angle by using a polarization raman spectroscopy. As a result, the average a of the angles of the discotic planes against the support was 40°, and the average b of the angles of the discotic planes against the air interface was 45°. It was confirmed that inclination of the discotic planes varied from the transparent support interface to the air interface in the hybrid alignment. The polarizing plate was turned into the crossed nicols state, and unevenness of the obtained optical compensation film was evaluated. As a result, unevenness was not detected by observation from the front and from the direction at 60° against the normal line.

Table 11 shows main properties of the transparent support and the optically anisotropic layer of the optical compensation film KH-7. The lower and upper limit values of Rth according to the condition of (1) or (2) are also shown in Table 11.

(Production of Polarizer)

A polarizer HF-01 was produced under the same conditions by the same method as Example 5. The polarizer had a width of 660 mm, and left and right thicknesses of 20 μm.

(Production of Polarizing Plate)

The surface of the polymer substrate PK-3 of the optical compensation film KH-7 was attached to one side of the polarizer HF-01 using a polyvinyl alcohol adhesive. Further, a triacetylcellulose film FUJI TAC TD-80U was subjected to a surface saponification treatment in the same manner as WO 02/46809, Example 5, and attached to the other side of the polarizer using a polyvinyl alcohol adhesive.

The optical compensation film was disposed such that the retardation axis of the polymer substrate PK-3 was parallel to the transmission axis of the polarizer, and the triacetylcellulose film was disposed such that the retardation axis of the triacetylcellulose film was perpendicular to the transmission axis of the polarizer. Thus, a polarizing plate HB-7 was produced.

### Example 8

### Optical Compensation Film of the Second Embodiment

(Preparation of Polymer Substrate, Undercoat Layer, and Alignment Layer)

An alignment layer was formed on the transparent substrate PK-3 produced in Example 5 in the same manner as Example 5. The rubbing axis of the alignment layer was parallel to the retardation axis.

(Formation of Optically Anisotropic Layer)

41.01 kg of a discotic compound (A) equal to that used in Example 5, 4.06 kg of an ethylene oxide-modified trimethylolpropane triacrylate V#360 available from Osaka Organic Chemical Industry Ltd., 0.35 kg of a cellulose acetate butyrate CAB531-1 available from Eastman Chemicals Co., 1.35 kg of a photopolymerization initiator IRGACURE 907 available from Ciba-Geigy, 0.45 kg of a sensitizer KAYACURE DETX available from Nippon Kayaku Co., Ltd., and 0.1 kg of a fluorine-containing surfactant equal to that used in Example 5 were dissolved in 102 kg of methyl ethyl ketone to obtain a coating liquid. The coating liquid was continuously applied to the alignment layer by a #3.6 wire bar, and heated at 130° C. for 2 minutes to align the discotic compound. Then, the resultant laminate was irradiated with UV at 100° C. for 1 minute by a 120-W/cm high-pressure mercury vapor lamp to polymerize the discotic compound, and was cooled to the room temperature. Thus an optical compensatory sheet KH-8 comprising an optically anisotropic layer was produced.

The formed discotic liquid crystal layer had a thickness of 2.2 μm. The film comprising the discotic compound was obliquely cut, and measured with respect to each mean tilt angle by using a polarization raman spectroscopy. As a result, the average a of the angles of the discotic planes of the discotic compound against the substrate interface was 35°, and the average b of the angles of the discotic planes against the air interface was 30°. It was confirmed that inclination of the discotic planes varied from the transparent support interface to the air interface in the hybrid alignment. The polarizing plate was turned into the crossed nicols state, and unevenness of the obtained optical compensatory sheet was evaluated. As a result, unevenness was not detected by observation from the front and from the direction at 60° against the normal line.

Table 11 shows main properties of the transparent support and the optically anisotropic layer of the optical compensation film KH-8. The lower and upper limit values of Rth of the transparent support are also shown in Table 11.

(Production of Polarizer)

A polarizer HF-01 was produced under the same conditions by the same method as Example 5. The polarizer had a width of 660 mm, and left and right thicknesses of 20 μm.

(Production of Polarizing Plate)

The surface of the polymer substrate PK-3 of the optical compensatory sheet KH-8 was attached to one side of the polarizer HF-01 using a polyvinyl alcohol adhesive. Further, a triacetylcellulose film FUJI TAC TD-80U was subjected to a surface saponification treatment in the same manner as WO 02/46809, Example 1, and attached to the other side of the polarizer using a polyvinyl alcohol adhesive.

The optical compensation film was disposed such that the retardation axis of the polymer substrate PK-3 was parallel to the transmission axis of the polarizer, and the triacetylcellulose film was disposed such that the retardation axis of the triacetylcellulose film was perpendicular to the transmission axis of the polarizer.

Thus, a polarizing plate HB-8 was produced.

### Comparative Example 2

A commercially-available, wide-viewing, polarizing plate (LPT-HL56-12 available from Sanritz Corporation), where a conventional optical compensation film manufactured by Fuji Photo Film Co., Ltd., an iodine-based polarizer, and a protective TAC film were integrated, was evaluated together with the films of Examples 7 and 8.

(Evaluation in TN Liquid Crystal Cell)

From a liquid crystal display using a TN liquid crystal cell (AQUOS LC20C1S manufactured by Sharp Kabushiki Kaisha), a pair of polarizing plates were peeled off. Instead of the peeled polarizing plates, the commercially-available, wide-viewing polarizing plate and the polarizing plates HB-7 and HB-8 produced in Examples 7 and 8 were attached to the observer side and the backlight side using an adhesive respectively such that the optical compensation films faced the liquid crystal cell. The absorption axis of the polarizing plate on the observer side was parallel to the rubbing axis of the liquid crystal layer on the observer side, and perpendicular to the absorption axis of the polarizing plate on the backlight side. The viewing angles of thus produced liquid crystal displays were evaluated using 8 classifications of from black display (L0) to white display (L7) by a measuring apparatus EZ-Contrast 160D manufactured by ELDIM. The results are shown in Tables 12 and 13.

TABLE 11
Properties of optically anisotropic layer and
transparent support

| | | | | Optically anisotropic layer | | | |
|---|---|---|---|---|---|---|---|
| | | | | | | | Angle at air |
| | Transparent support | | | | Mean tilt | Angle at | interface |
| | Rth | | | Thickness | angle | support side | side |
| | (nm) | 255 × e^{-0.66d} | 330 × e^{-0.46d} | d (μm) | β (deg.) | a (deg.) | b (deg.) |
| Example 7 | 125 | 123 | 199 | 1.1 | 43 | 40 | 45 |
| Example 8 | 125 | 60 | 120 | 2.2 | 33 | 35 | 30 |

TABLE 12
Viewing angle (at contrast ratio of 10 or more)

| | Polarizing plate | Up | Down | Left | Right | Total |
|---|---|---|---|---|---|---|
| Example 7 | HB-7 | 47° | 64° | 60° | 60° | 231° |
| Example 8 | HB-8 | 49° | 63° | 64° | 64° | 240° |
| Comparative | Commercially- | 80° | 60° | 80° | 80° | 300° |
| Example 2 | available, | | | | | |
| (commercial | wide-viewing | | | | | |
| product) | polarizing plate | | | | | |

TABLE 13
Grayscale inversion angle
(angle at which tone levels L1 and L2 intersect)

| | Underside |
|---|---|
| Example 7 | 38° |
| Example 8 | 33° |
| Comparative Example 2 | 30° |
| (commercial product) | |

(Evaluation of Unevenness on Liquid Crystal Display Panel)

In Example 7, as compared with Example 5, the thickness d of the optically anisotropic layer was smaller and did not satisfy the relation of (6) with Rth of the transparent support, so that the viewing angles were narrower and the grayscale inversion was less improved. Also in Example 8, the relation of (6) between the thickness d of the optically anisotropic layer and the retardation Rth of the transparent support was not satisfied, so that the viewing angles in the directions of up, down, left, and right was insufficient, and the improvement of the grayscale inversion on the underside was slightly smaller than that of Example 5. The display panel of each liquid crystal display of Examples 7 and 8 was entirely controlled at the grey level to evaluate unevenness. Unevenness was not detected by observation from any direction in Examples 7 and 8.

In Comparative Example 2 using the commercially-available, wide-viewing polarizing plate, the grayscale inversion on the underside did not reach the desired level though the viewing angles in the directions of up, down, left, and right were satisfactory. In conclusion, among the optical compensation films according to the second embodiment, the film of Example 5 satisfying the conditions of (5) and (6) had the largest total viewing angle in the directions of up, down, left, and right, and had most improved grayscale inversion property on the underside.

Having described our invention as related to the present embodiments, it is our intention that the invention not be limited by any of the details of the description, unless otherwise specified, but rather be construed broadly within its spirit and scope as set out in the accompanying claims.

1. An optical compensation film for a liquid crystal display comprising a pair of polarizers and a liquid crystal cell, comprising a transparent support and an optically anisotropic layer formed of a composition comprising a discotic compound, wherein angles of the discotic planes of the discotic compound molecules to a film plane varies in a thickness direction, and when a (deg.) is an average of angles between the film plane and the major axes (the discotic planes) of the discotic compound molecules, b (deg.) is an average of angles between an air interface and the major axes (the discotic planes) of the discotic compound molecules at the interface, β is a mean value of a (deg.) and b (deg.), and Rth (nm) is a retardation of only the transparent support in the thickness direction, β satisfies the following equation or is within the range of ±7% thereof;
β=−0.0006×Rth²+0.1125×Rth+35.

2. The optical compensation film of claim 1, wherein when d (μm) is a thickness of the optically anisotropic layer and Rth (nm) is the retardation of only the transparent support in the thickness direction, d satisfies the following equation or is within the range of ±10% thereof;
d=−0.0115×Rth+3.0.

3. The optical compensation film of claim 1, wherein when d (μm) is the thickness of the optically anisotropic layer and φ (deg.) is a twist angle of the discotic compound from the transparent support interface to the air interface, φ satisfies the following equation or is within the range of ±15% thereof;
φ(d)=21.3×d−39.8.

4. An optical compensation film for a liquid crystal display comprising a pair of polarizers and a liquid crystal cell, comprising a transparent support and an optically anisotropic layer formed of a composition comprising a discotic compound, wherein when a (deg.) is an average of tilt angles of the major axes (the discotic planes) of the discotic compound molecules at an interface between the optically anisotropic layer and the transparent support, and b (deg.) is an average of tilt angles of the major axes (the discotic planes) of the discotic compound molecules at an air interface on the side of a liquid crystal cell, a (deg.) and b (deg.) are within the ranges of 20≦a≦80 and 20≦b≦80, and satisfy the relation of − 5/9×a+45≦b≦− 5/9×a+110.

5. The optical compensation film of claim 4, wherein when Rth (nm) is a retardation of only the transparent support in a thickness direction and d (μm) is only a thickness of the optically anisotropic layer, Rth (nm) and d (μm) satisfy the relation of 255×Exp(−0.66×d)<Rth<330×Exp(−0.46×d).

6. The optical compensation film of claim 1, wherein the optical compensation film has a photoelastic coefficient of 16×10⁻¹² (1/Pa) or less.

7. The optical compensation film of claim 4, wherein the optical compensation film has a photoelastic coefficient of 16×10⁻¹² (1/Pa) or less.

8. An ellipsoidal polarizing plate comprising a transparent protective film, a polarizing film, and the optical compensation film of claim 1.

9. An ellipsoidal polarizing plate comprising a transparent protective film, a polarizing film, and the optical compensation film of claim 4.

10. A liquid crystal display comprising the optical compensation film of claim 1.

11. A liquid crystal display comprising the optical compensation film of claim 4.

12. A liquid crystal display comprising a pair of polarizers and a liquid crystal cell disposed therebetween, wherein at least one of the polarizers is the ellipsoidal polarizing plate of claim 8.

13. A liquid crystal display comprising a pair of polarizers and a liquid crystal cell disposed therebetween, wherein at least one of the polarizers is the ellipsoidal polarizing plate of claim 9.

14. The liquid crystal display of claim 12, wherein the liquid crystal display has a total viewing angle of 240° or more in the directions of up, down, left, and right at a contrast of 10 or more, and has a grayscale inversion angle of 37° or more on the underside.

15. The liquid crystal display of claim 13, wherein the liquid crystal display has a total viewing angle of 240° or more in the directions of up, down, left, and right at a contrast of 10 or more, and has a grayscale inversion angle of 37° or more on the underside.
